(19) United States
(12) Patent Application Publication
(10) Pub. No.: US 2025/0250854 A1
(43) Pub. Date: Aug. 7, 2025

(54) CONFIGURABLE MULTI-TRACK SYSTEM AND METHOD FOR SHEETING AN OPENING IN A BUILDING

(71) Applicant: MARHAYGUE, LLC, Georgetown, SC (US)

(72) Inventor: Guerry E. Green, Georgetown, SC (US)

(21) Appl. No.: 18/430,764

(22) Filed: Feb. 2, 2024

(51) Int. Cl. E06B 9/52

(52) U.S. Cl. CPC E06B 9/52

(57) ABSTRACT

Disclosed herein are examples of a configurable multi-track sheet system for enclosing an opening in a building, such as a porch, gazebo, balcony, window, or other opening to the outdoors. Said examples include a lineal track member having a length and a depth, and defining a main track and an auxiliary track each running parallel to the length and perpendicular to the depth, and defining a first side track opposite a second side track each running parallel to the length and perpendicular to the depth. A removable lineal sheet retention member configured to be engaged, at least in part, by the lineal track member, via male-female type engagement. A first removable lineal cap member being attachable to the lineal track member, via male-female type engagement, wherein the first removable lineal cap member comprises two legs for attaching to the lineal track member.

### FIELD

This disclosure relates to a sheeting system for screening or sheeting a porch or other opening in a building. In particular, a configurable multi-track system that allows for sheeting to be placed on the inside, outside, or other position on framing to allow for rapid installation of sheeting.

### BACKGROUND

Current approaches for sheeting systems for openings in buildings typically involve permanent, fixed-in-time track members, and limited options for screen retention, maintenance, and repair. These systems often lack flexibility and ease of installation, making it difficult for users to customize the screen system, make fixes, or update to their specific needs and preferences.

One approach in the prior art involves the use of fixed track members with permanent screens that are permanently attached to an opening in a building. These track members may have limited options for screen retention, restricting the ability to easily modify or replace the screen. Additionally, the fixed track members may not provide a secure and reliable engagement with the screen retention and cap members, leading to potential rips, separation from the frame, and instability.

Further solutions required a different lineal for each frame mounting location, whether it was on the outside of the frame, on the inside, or placed butted to one another. This required purchasing different components that often add to the complexity of screening an opening such as a porch.

Furthermore, some existing screen systems may require complex installation processes, involving multiple tools and specialized knowledge. This can be time-consuming and inconvenient for users, especially those without prior experience or expertise in screen installation.

Thus, there is a long sought need for a single lineal multi-track system that is user-friendly and configurable to a variety of openings in a building. The disclosure herein sets to address the issues in the prior art.

### SUMMARY

In some aspects, the techniques described herein relate to a configurable multi-track sheet system for an opening in a building, including: (a) a lineal track member having a length and a depth, and defining a main track and an auxiliary track each running parallel to the length and perpendicular to the depth, and defining a first side track opposite a second side track each running parallel to the length and perpendicular to the depth; (b) a removable lineal sheet retention member configured to be engaged, at least in part, by the lineal track member, via male-female type engagement, along at least a portion of: (i) the main track; (ii) the auxiliary track; (iii) the first side track; or (iv) the second side track, and (c) a first removable lineal cap member being attachable to the lineal track member, via male-female type engagement, for covering: (i) the main track and the auxiliary track; (ii) the first side track; or (iii) the second side track, wherein the first removable lineal cap member includes two legs for attaching to the lineal track member.

In some aspects, the techniques described herein relate to a configurable fixed or removable sheet system for an opening in a building, including: (a) a lineal track member having a length and a depth, and defining a main track and an auxiliary track each running parallel to the length and perpendicular to the depth, and defining a first side track opposite a second side track each running parallel to the length and perpendicular to the depth; (b) a corner member configured to link two adjacent lineal track members; (c) a removable lineal sheet retention cap configured to be engaged, at least in part, by the lineal track member, via male-female type engagement, along at least a portion of: (i) the first side track; or (ii) the second side track, and (c) a first removable lineal trim piece being attachable to the lineal track member, via male-female type engagement, for covering: (i) the main track and the auxiliary track; (ii) the first side track; or (iii) the second side track, wherein the first removable lineal trim piece includes two legs for attaching to the lineal track member.

In some aspects, the techniques described herein relate to a method of using a configurable multi-track sheet system, the method including: (a) providing a lineal track member having a length and a depth, the lineal track member defining a main track and an auxiliary track each running parallel to the length and perpendicular to the depth, and defining a first side track opposite a second side track each running parallel to the length and perpendicular to the depth; (b) providing a removable lineal sheet retention member configured to be engaged, at least in part, by the lineal track member, via male-female type engagement, along at least a portion of: (i) the main track; (ii) the auxiliary track; (iii) the first side track; or (iv) the second side track, and (c) providing a first removable lineal cap member being attachable to the lineal track member, via male-female type engagement, for covering: (i) the main track and the auxiliary track; (ii) the first side track; or (iii) the second side track.

In some aspects, the techniques described herein relate to a configurable multi-track sheet system: wherein the removable lineal sheet retention member is a lineal spline configured to be engaged by the auxiliary track; and wherein the first removable lineal cap member is a first removable lineal trim piece for covering the first side track.

In some aspects, the techniques described herein relate to a configurable multi-track sheet system: wherein the removable lineal sheet retention member is a lineal spline configured to be engaged by the auxiliary track; and wherein the first removable lineal cap member is a first removable lineal trim piece for covering the second side track.

In some aspects, the techniques described herein relate to a configurable multi-track sheet system, further including a second removable lineal trim piece for covering the second side track.

In some aspects, the techniques described herein relate to a configurable multi-track sheet system: wherein the removable lineal sheet retention member is a second removable lineal cap configured to be engaged by the first side track; and wherein the first removable lineal cap member is a first removable lineal trim piece for covering the second side track.

In some aspects, the techniques described herein relate to a configurable multi-track sheet system, further including a second removable lineal trim piece for covering the main track and the auxiliary track.

In some aspects, the techniques described herein relate to a configurable multi-track sheet system: wherein the removable lineal sheet retention member is a second removable lineal cap configured to be engaged by the second side track; and wherein the first removable lineal cap member is a first removable lineal trim piece for covering the main track and the auxiliary track.

In some aspects, the techniques described herein relate to a configurable multi-track sheet system, further including a second removable lineal trim piece for covering the first side track.

In some aspects, the techniques described herein relate to a configurable multi-track sheet system: wherein the removable lineal sheet retention member is a second removable lineal cap configured to be engaged by the second side track; and wherein the first removable lineal cap member is a first removable lineal trim piece for covering the first side track.

In some aspects, the techniques described herein relate to a configurable multi-track sheet system, further including a second removable lineal trim piece for covering the main track and the auxiliary track.

### BRIEF DESCRIPTION OF THE DRAWINGS

Many aspects of the present disclosure will be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views. It should be recognized that these implementations and embodiments are merely illustrative of the principles of the present disclosure. Therefore, in the drawings:

FIG. 1 is a flowchart of an example method of using a configurable multi-track sheet system according to the present disclosure.

FIG. 2A is a front perspective view of a partial illustration of an example building with an example surface-mounted track member frame of an example configurable multi-track sheet system added about an example window, according to the present disclosure.

FIG. 2B is a rear perspective view of a partial illustration of an example building with an example surface-mounted track member frame of an example configurable multi-track sheet system added about an example window, according to the present disclosure.

FIG. 3 is a cross-sectional view of an illustration of an example lineal track member of an example surface-mounted track member frame of an example configurable multi-track sheet system with fastener(s), and with a screen added to the track member frame via a removable lineal screen retention member, and taken along line 3-3 of FIG. 2B, according to the present disclosure.

FIG. 4A is a rear perspective view of a partial illustration of a first step for disassembling an example surface-mounted track member frame of an example configurable multi-track sheet system added about an example window, according to the present disclosure.

FIG. 4B is a rear perspective view of a partial illustration of a second step for disassembling an example surface-mounted track member frame of an example configurable multi-track sheet system added about an example window, according to the present disclosure.

FIG. 4C is a front perspective view of a partial illustration of a third step for disassembling an example surface-mounted track member frame of an example configurable multi-track sheet system added about an example window, according to the present disclosure.

FIG. 4D is a front perspective view of a partial illustration of a fourth step for disassembling an example surface-mounted track member frame of an example configurable multi-track sheet system added about an example window, according to the present disclosure.

FIG. 4E is a front perspective view of a partial illustration of a fifth step for disassembling an example surface-mounted track member frame of an example configurable multi-track sheet system added about an example window, according to the present disclosure.

FIG. 4F is a front perspective view of a partial illustration of a sixth step for disassembling an example surface-mounted track member frame of an example configurable multi-track sheet system added about an example window, according to the present disclosure.

FIG. 4G is a front perspective view of a partial illustration of a seventh step for disassembling an example surface-mounted track member frame of an example configurable screen system added about an example window, according to the present disclosure.

FIG. 4H is a front perspective view of a partial illustration of an eighth step for disassembling an example surface-mounted track member frame of an example configurable multi-track sheet system added about an example window, according to the present disclosure.

FIG. 4I is a front perspective view of a partial illustration of a ninth step for disassembling an example surface-mounted track member frame of an example configurable multi-track sheet system added about an example window, according to the present disclosure.

FIG. 4J is a front perspective view of a partial illustration of a tenth step for disassembling an example surface-mounted track member frame of an example configurable multi-track sheet system added about an example window, according to the present disclosure.

FIG. 4K is a front perspective view of a partial illustration of an eleventh step for disassembling an example surface-mounted track member frame of an example configurable multi-track sheet system added about an example window, according to the present disclosure.

FIG. 5 is a cross-sectional view of an illustration of an example lineal track member of an example surface-mounted track member frame of an example configurable multi-track sheet system with a sheet or screen removed, according to the present disclosure.

FIG. 6 is a front perspective view of a partial illustration of an example building with an example interior-mounted track member frame of an example configurable multi-track sheet system added about an example window, according to the present disclosure.

FIG. 7 is a cross-sectional view of an illustration of an example lineal track member of an example interior-mounted track member frame of an example configurable multi-track sheet system with fastener(s), and with a screen added to the track member frame via a removable lineal screen retention cap, and taken along line 7-7 of FIG. 6, according to the present disclosure.

FIG. 8A is a rear perspective view of a partial illustration of a first step for disassembling an example interior-mounted track member frame of an example configurable multi-track sheet system added about an example window, according to the present disclosure.

FIG. 8B is a rear perspective view of a partial illustration of a second step for disassembling an example interior-mounted track member frame of an example configurable multi-track sheet system added about an example window, according to the present disclosure.

FIG. 8C is a rear perspective view of a partial illustration of a third step for disassembling an example interior-mounted track member frame of an example configurable multi-track sheet system added about an example window, according to the present disclosure.

FIG. 8D is a rear perspective view of a partial illustration of a fourth step for disassembling an example interior-mounted track member frame of an example configurable multi-track sheet system added about an example window, according to the present disclosure.

FIG. 8E is a front perspective view of a partial illustration of a fifth step for disassembling an example interior-mounted track member frame of an example configurable multi-track sheet system added about an example window, according to the present disclosure.

FIG. 8F is a front perspective view of a partial illustration of a sixth step for disassembling an example interior-mounted track member frame of an example configurable multi-track sheet system added about an example window, according to the present disclosure.

FIG. 8G is a front perspective view of a partial illustration of a seventh step for disassembling an example interior-mounted track member frame of an example configurable multi-track sheet system added about an example window, according to the present disclosure.

FIG. 8H is a front perspective view of a partial illustration of an eighth step for disassembling an example interior-mounted track member frame of an example configurable multi-track sheet system added about an example window, according to the present disclosure.

FIG. 8I is a front perspective view of a partial illustration of a ninth step for disassembling an example interior-mounted track member frame of an example configurable multi-track sheet system added about an example window, according to the present disclosure.

FIG. 8J is a front perspective view of a partial illustration of a tenth step for disassembling an example interior-mounted track member frame of an example configurable multi-track sheet system added about an example window, according to the present disclosure.

FIG. 8K is a front perspective view of a partial illustration of an eleventh step for disassembling an example interior-mounted track member frame of an example configurable multi-track sheet system added about an example window, according to the present disclosure.

FIG. 8L is a front perspective view of a partial illustration of a twelfth step for disassembling an example interior-mounted track member frame of an example configurable multi-track sheet system added about an example window, according to the present disclosure.

FIG. 8M is a front perspective view of a partial illustration of a thirteenth step for disassembling an example interior-mounted track member frame of an example configurable multi-track sheet system added about an example window, according to the present disclosure.

FIG. 9A is a front perspective view of an illustration of an example corner member of an example interior-mounted track member frame of an example configurable multi-track sheet system, according to the present disclosure.

FIG. 9B is an exploded rear perspective view of an illustration of an example corner member and two adjacent lineal track members of an example interior-mounted track member frame of an example configurable multi-track sheet system, according to the present disclosure.

FIG. 10 is a front perspective view of a partial illustration of an example building with an example interior-mounted track member frame with a flexible screen panel of an example configurable multi-track sheet system added about an example window, according to the present disclosure.

FIG. 11 is a cross-sectional view of an illustration of an example lineal track member of an example interior-mounted track member frame with a flexible screen panel of an example configurable multi-track sheet system, taken along line 11-11 of FIG. 10, according to the present disclosure.

FIG. 12 is a front perspective view of a partial illustration of an example building with two example interior-mounted track member frames each with a flexible screen panel added about an example window, according to the present disclosure.

### DETAILED DESCRIPTION

The presently disclosed subject matter now will be described more fully hereinafter with reference to the accompanying drawings, in which some, but not all embodiments of the presently disclosed subject matter are shown. Like numbers refer to like elements throughout. The presently disclosed subject matter may be embodied in many different forms and should not be construed as limited to the embodiments set forth herein; rather, these embodiments are provided so that this disclosure will satisfy applicable legal requirements. Indeed, many modifications and other embodiments of the presently disclosed subject matter set forth herein will come to mind to one skilled in the art to which the presently disclosed subject matter pertains having the benefit of the teachings presented in the foregoing descriptions and the associated drawings. Therefore, it is to be understood that the presently disclosed subject matter is not to be limited to the specific embodiments disclosed and that modifications and other embodiments are intended to be included within the scope of the appended claims.

Throughout this specification and the claims, the terms “comprise,” “comprises”, and “comprising” are used in a non-exclusive sense, except where the context requires otherwise. Likewise, the term “includes” and its grammatical variants are intended to be non-limiting, such that recitation of items in a list is not to the exclusion of other like items that can be substituted or added to the listed items.

### I. EXAMPLE USE CASE SCENARIO

The configurable multi-track sheet systems according to the present disclosure present a novel approach, and one or more technical steps and/or solutions, to addressing the challenges and deficiencies in the prior art. For example, to addressing the challenges associated with mounting to different framing, and to accepting multiple styles of sheets, including vinyl screening, metal screening, plastic or polymer sheets, and other sheets that may be installed to keep pests, insects, and small animals from entering or egressing through openings in a building or structure.

In one aspect, systems and methods according to the present disclosure provide a versatile, user-friendly, and easily configurable solution, offering unique advantages over traditional sheet systems.

In another aspect, systems and methods according to the present disclosure overcome the challenges and deficiencies in the prior art by providing a configurable multi-track sheet system that offers flexibility, ease of installation, and a secure engagement between track members, sheet retention members, cap members, and the other components of the system described herein.

In another aspect, systems and methods according to the present disclosure relate to porch frame track and/or trim. In particular, in one aspect, the system and methods according to the present disclosure allow or facilitate permanent (fixed) installation, or removable attachment installation, of sheets, screens or screen-systems or any other flexible sheet (e.g. flexible plastic sheets, semi-flexible glass sheets, flexible impact resistant sheets, metal sheets, vinyl sheets, etc.) to building openings, and in areas prone to pests, insects, and small animals, or in areas where concern for opening—and boundary-access is elevated, without compromising aesthetics or décor.

In another aspect, systems and methods according to the present disclosure include a track member(s), a removable flexible sheet retention member(s), and a cap member(s), each contributing to the system's adaptability and ease of use.

In another aspect, system and methods according to the present disclosure relate to pre-existing frames for openings in a building or structure. For example, in one aspect, systems according to the present disclosures can be added to existing framing of a porch, or to the building, structure, or substrate defining the porch or opening that consists of framing, such as a window or door. Moreover, in one aspect, a system according to the present disclosure is a track member frame kit for standard, uniform, or industry/regulated-size frames, wherein the same kit can be used, with the same or different combination of kit parts, for an outer or inner frame surface mounted application, or for an interior frame surface mounted application. In another aspect, a system according to the present disclosure is a kit for forming a custom-sized track member frame for an opening in a building or structure. Example openings for the intended use include openings for porches, and other areas in buildings which may be sheeted or screened in, such as balconies, patios, gazebos, and windows.

In another aspect, a track member frame according to the present disclosure may be useful for one entire opening in a building or frame. In another aspect, an opening according to the present disclosure may require one or more track member frames (e.g., engaged, side by side, forming a mullion type structure from two adjacent back-to-back track members, for example; or stacked).

In another aspect, an example utility of the systems and methods according to the present disclosure lies in their ability to allow users to dynamically place flexible sheets in various configurations to suit their specific needs. For example, unlike fixed screen systems in the prior art, a track member according to the present disclosure defines a main track(s), an auxiliary track(s), and first and second (set of) side track. This configuration permits screens, for example, to be engaged at different points along these tracks, facilitating a wide range of screen placements for openings of varying sizes and dimensions.

In another aspect, the removable nature of sheet/screen retention members and/or cap members according to the present disclosure (e.g., retention cap(s) or trim cap(s)/trim pieces) is a feature that enhances the system's lifespan and user experience. For example, in one aspect, users of the systems and methods described herein can effortlessly detach and replace individual components for replacement, maintenance, or repair purposes, eliminating the need for extensive dismantling or specialized tools. These aspects address the drawbacks of traditional, permanent screens, providing a practical and cost-effective solution for long-term use.

In another aspect, systems and methods according to the present disclosure provide protection for vulnerable openings to a modern home, especially those having many windows, doors, columns, patios, and partially enclosed outdoor spaces, for better enjoyment of scenic views and landscapes. Moreover, “outdoor architecture,” common to coastal areas, favors more natural light and access to fresh air; thus, the systems and methods according to the present disclosure also provide a technical solution to these fields.

In another aspect, in a surface-mounted (outer or inner frame surface) application, a track member according to the present disclosure can be installed directly about an opening without the need for corner pieces. This practical application is advantageous for quick installations or for situations where a sleek, unobtrusive appearance is desired. In one aspect, the track member can be installed on the 1.5-inch side of a 2 by 4 panel for an opening.

In another aspect, in an interior-mounted configuration, and with the inclusion of a corner member(s) as described herein, the systems and methods according to the present disclosure can be installed directly onto the interior surface of a frame. This practical application provides a polished and refined appearance, ideal for architectural settings where aesthetics is a priority. Moreover, this practical application dispenses with any need for mitering the track member(s) described herein. In one aspect, the track member can be installed on the 3.5-inch side of a 2 by 4 panel for a frame.

In another aspect, the systems and methods according to the present disclosure have an adaptability that extends to multiple functions, serving not only as a multi-track sheet system for accepting multiple styles of sheets, including flexible or fixed sheets, but also as framework for additional features. The lineal track member, in conjunction with the removable lineal cap members, can accommodate various attachments, such as additional trims or dividers, and different sheet systems, offering users a comprehensive solution for diverse architectural needs.

In another aspect, the systems according to the present disclosure, or components thereof, as described herein, may be made and/or extruded to match the exterior appearance of a building, opening, or frame. For example, it may be selected to match the color of a vinyl window frame so that it looks like part of ornamental trim structures expected around windows and doors, and carried onto porches and other sheeting structures.

### II. SYSTEMS AND METHODS

In one aspect, the present disclosure provides a configurable multi-track sheet system for an opening in a building. An example of the configurable multi-track sheet system includes: (a) one or more track member(s), in one particular aspect, at least four track member(s), each defining at least one main track and each defining at least one auxiliary track; (b) one or more removable sheet retention member(s), in one particular aspect, at least four removable sheet retention members; and (c) a plurality of removable cap member each being attachable to the track member for covering: (i) the main track and the auxiliary track; (ii) the first side track; or (iii) the second side track, when the track(s) are or not used or occupied by other system components.

In one aspect, an example configurable multi-track sheet system according to the present disclosure also includes: (d) a corner member configured to engage with an underlying substrate or structure. In particular, in another aspect, a corner member engages with an underlying substrate or structure via one or more screws, wherein a portion of each screw traverses the corner member body through an aperture or hole and a portion is embedded or anchored into the underlying substrate or structure. In another aspect, a corner member also links two adjacent track members and, with an opposite same side corner member, also is configured to securely hold a track member in place. In another aspect, for a configurable multi-track sheet system with or without a corner member(s), the track member itself is configured to engage with the underlying substrate or structure. In particular, in another aspect, the track member engages an underlying substrate or structure via one or more screws, wherein a portion of each screw traverses or extends through the track member body through an aperture or hole at various spaced locations along a length of the track member, and a portion is embedded or anchored into the underlying substrate or structure. In another aspect, there are no exposed fasteners as, for example, screws are always recess and made flush into the track member body within, for example, a track.

In one aspect, an example configurable multi-track sheet system according to the present disclosure allows for formation of a track member frame. In one specific aspect, a track member frame may include a plurality of track members and a plurality of corner members and may be configured for an interior-mounted application about a door, window, or other opening or entry way to a building or structure. In another specific aspect, a track member frame may include a plurality of track members and no corner members and may be configured for an outer or interior surface-mounted installation about a door, window, or other opening or entry way to a building or structure.

In one aspect, each of the one or more track members of an example configurable multi-track sheet system according to the present disclosure is manufactured using lineal extrusion techniques and, therefore, is a lineal track member. In particular, in another aspect, a lineal track member has a length and a depth. Moreover, in another aspect, each of the main track(s) and the auxiliary track(s) run parallel to the length and perpendicular to the depth of the lineal track member. In another aspect, the lineal track member also defines a first side track (left side) opposite a second side track (right side) each also running parallel to the length and perpendicular to the depth of the lineal track member.

In one aspect, each of the one or more removable sheet retention members of an example configurable multi-track sheet system according to the present disclosure is manufactured using lineal extrusion techniques and, therefore, is a lineal removable sheet retention member. In particular, in another aspect, a lineal removable sheet retention member is configured to be engaged, at least in part, by a lineal track member, via male-female type engagement, along at least a portion of: (i) the main track; (ii) the auxiliary track; (iii) the first side track; or (iv) the second side track. In particular, in one aspect, the one or more lineal removable sheet retention members are a plurality of lineal splines configured to be engaged by the auxiliary track of each of the lineal track members of the configurable sheet system, to securely hold a sheet edge for a sheet or panel thereof, wherein the first removable lineal cap member is a first removable lineal trim piece for covering the main track and the auxiliary track. Furthermore, in another aspect, the one or more lineal removable sheet retention members are instead a plurality of removable lineal sheet retention caps each configured to be engaged by a side track of a lineal track member; and wherein the first removable lineal cap member is a first removable lineal trim piece for covering the main track and the auxiliary track.

In one aspect, each of the one or more removable cap members of an example configurable multi-track sheet system according to the present disclosure is manufactured using lineal extrusion techniques and, therefore, is a lineal removable cap member. In particular, in another aspect, a lineal removable cap member is configured as a lineal trim piece for aesthetically covering the track(s) of a lineal track member. In particular, in another aspect, a lineal removable cap member is configured to be engaged, at least in part, by a lineal track member, via male-female type engagement, along at least a portion of: (i) the main track and the auxiliary track; (ii) the first side track; or (iii) the second side track, when the track(s) are or not used or occupied by other system components. Furthermore, in another aspect, a removable lineal cap member may be specifically configured to includes two legs for attaching to the lineal track member via press-fit or snap-fit or friction-fit type engagement. The two legs, in another aspect, may project out and allow for some bending to facilitate the press-fit or snap-fit or friction-fit type engagement.

In one aspect, the present disclosure also provides a method of using a configurable multi-track sheet system as described herein. One example of the method includes: (a) providing a track member having a length and a depth, the track member defining a main track and an auxiliary track, and defining a first side track opposite a second side track; (b) providing a removable sheet retention member configured to be engaged, at least in part, by the track member along at least a portion of: (i) the main track; (ii) the auxiliary track; (iii) the first side track; or (iv) the second side track, and (c) providing a first removable cap member being attachable to the track member for covering: (i) the main track and the auxiliary track; (ii) the first side track; or (iii) the second side track.

In one aspect, the example method of using the configurable multi-track sheet system according to the present disclosure also includes installing the track member onto a substrate via a corner member of the configurable flexible sheet system that is anchored onto the substrate, or via one or more fasteners extending through the track member and into the substrate, or via a combination of both.

In one aspect, a track frame according to the present disclosure is for installation around porch framing or framing for an opening in a building. The components of the track frame as described herein, in one aspect, are extruded vinyl or polymer. Moreover, the track frame may be added to a window frame, for example, on the casing along a window, may be added to the stile or to the surroundings of the glazing or glass features in a door, transom, or side light, or it may be added to the framing, sheathing, or the framing of the building.

### III. WITH REFERENCE TO THE FIGURES

The term “extruded” is used herein for convenience but jambs, sills and headers may be formed in any way customary in the industry, for example, pultruded and co-extruded with other materials. Resin fusion and vacuum fusion methods are also envisioned.

The term “frame” other than “track member frame” as used herein, and used in connection with a window or door, such as a “window frame” an “opening frame” or a “door frame,” refers to the structure that is attached to a building where an aperture is defined by the walls of the building for receiving a window or door (or receiving a vent or an appliance such as a wall-mounted air conditioner). The frame is typically a four-sided structure that is sealed to the opening made for it and that holds the window, door, vent, or appliance.

The term “building” will be used here for convenience to mean any structure with openings defined by its walls. The structure includes by way of example, and not of limitation, homes, apartment buildings, and commercial buildings. The word “walls” refers to barriers such as walls, ceilings, concrete stone or slab, brick or masonry, floors, reinforcements, and finishes, that are positioned between the inside of the building and its outside.

The term “lineal” refers to an extruded component (e.g., member, piece, etc.) having a uniform cross section perpendicular to its major dimension which major dimension is much longer than its other two dimensions; that is, the plane of any cross section perpendicular to the major dimension is defined by a line parallel to the major dimension.

The term “combination” carries its ordinary and customary meaning. The term “combination” is not intended to be specially-defined.

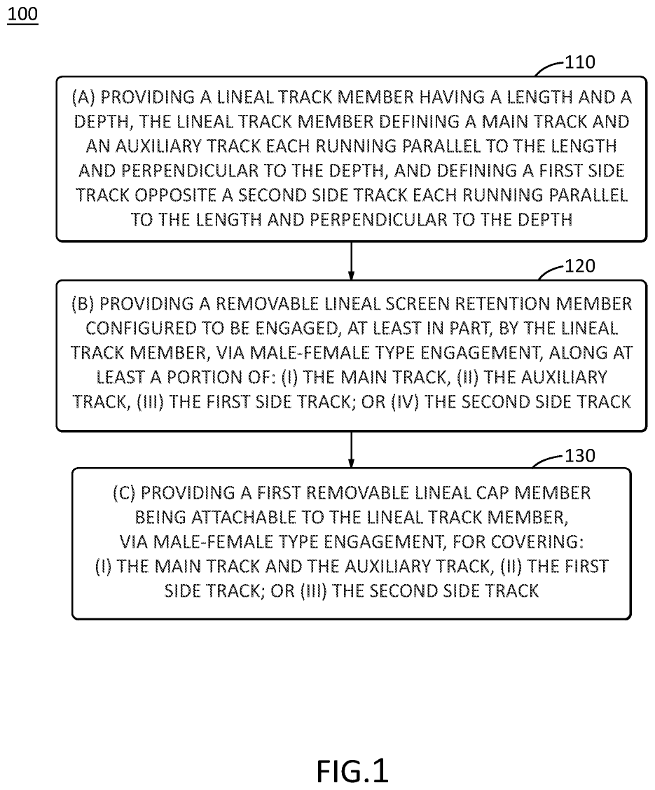

FIG. 1 is a flowchart of an example method of using a configurable multi-track system according to the present disclosure. In particular, FIG. 1 shows a method 100 including:

At step 110, providing a lineal track member having a length and a depth, the lineal track member defining a main track and an auxiliary track each running parallel to the length and perpendicular to the depth, and defining a first side track opposite a second side track each running parallel to the length and perpendicular to the depth.

At step 120, providing a removable lineal screen retention member configured to be engaged, at least in part, by the lineal track member, via male-female type engagement, along at least a portion of: (i) the main track, (ii) the auxiliary track, (iii) the first side track; or (iv) the second side track.

At step 130, providing a first removable lineal cap member being attachable to the lineal track member, via male-female type engagement, for covering: (i) the main track and the auxiliary track, (ii) the first side track; or (iii) the second side track.

Other methods will be described herein, and will be discernible from the following detailed description of systems and components according to the present disclosure.

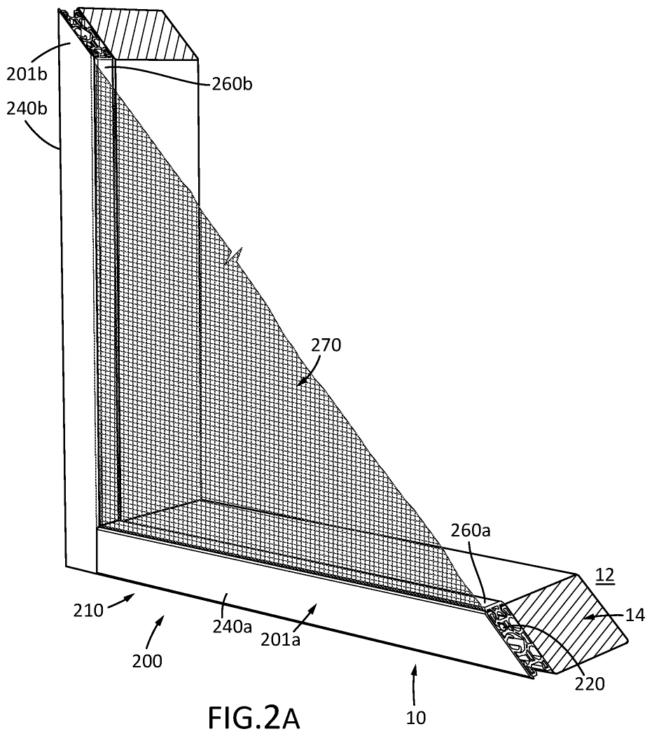

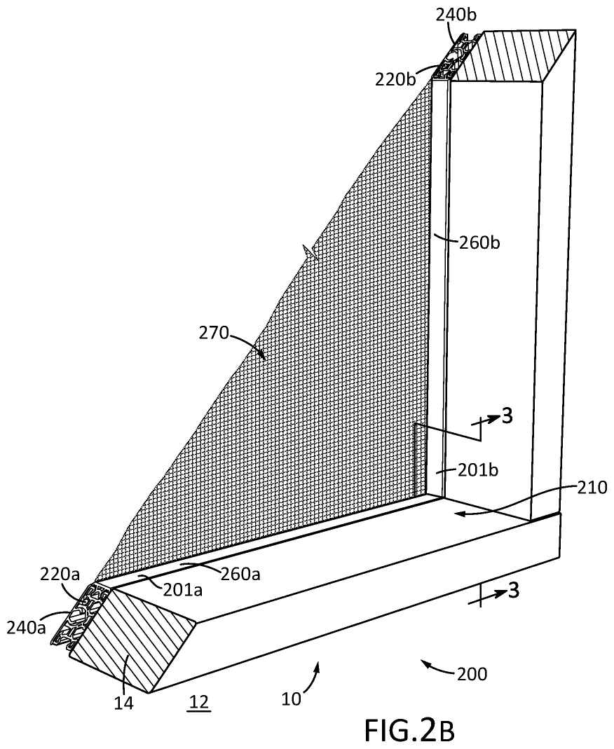

Turning now to FIGS. 2A-2B, FIG. 2A is a front perspective view of a partial illustration of an example building with an example surface-mounted track member frame of an example configurable screen system added about an example window, according to the present disclosure, and FIG. 2B is a rear perspective view of a partial illustration of the building with an example surface-mounted track member frame of an example configurable screen system added about the window, according to the present disclosure.

In particular, in FIGS. 2A and 2B, there is shown the corner of a window 10 of a building 12. The window 10 has a window frame 14, in particular, a rectangular window frame, and a window pane (not shown).

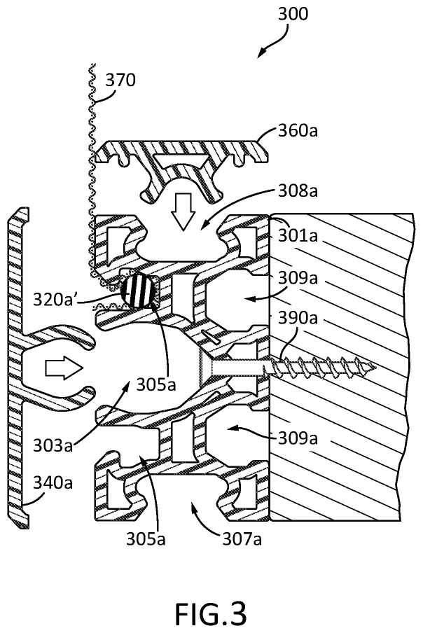

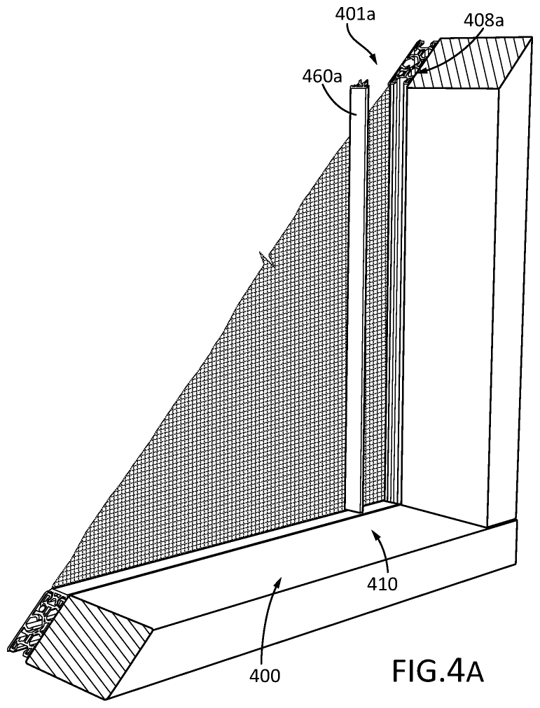

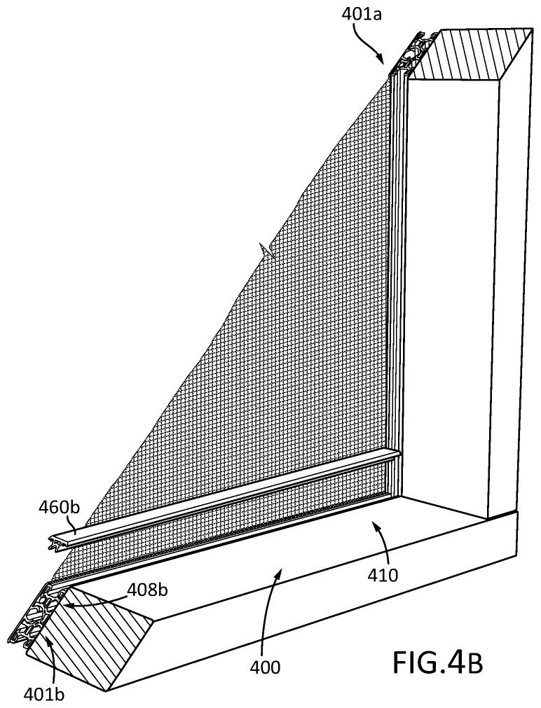

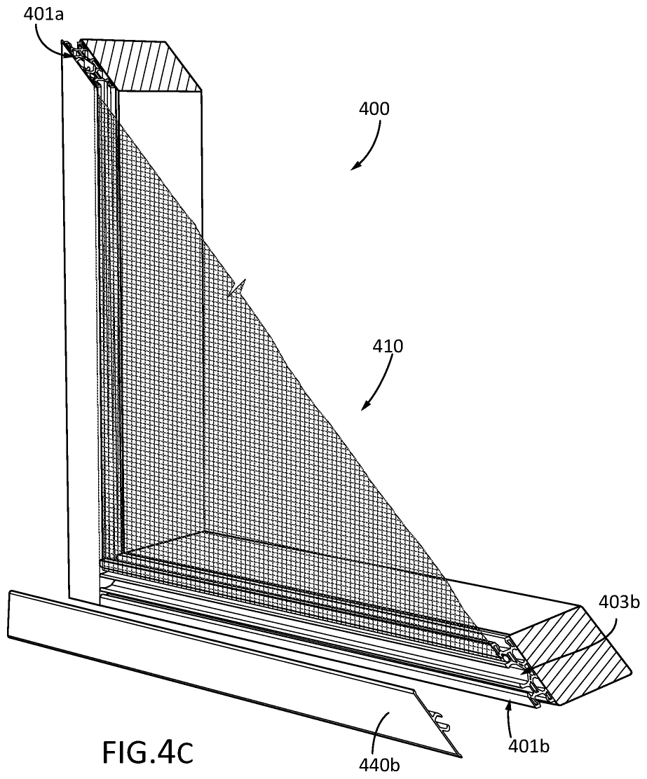

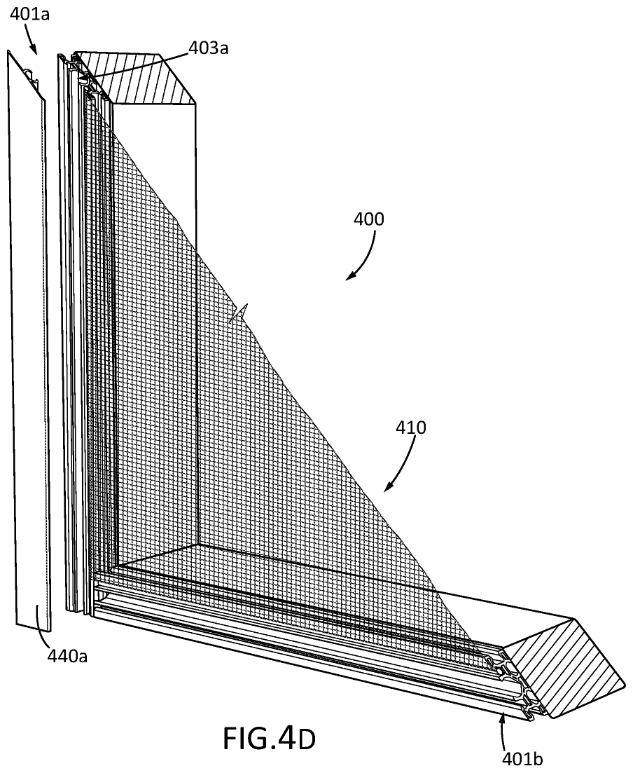

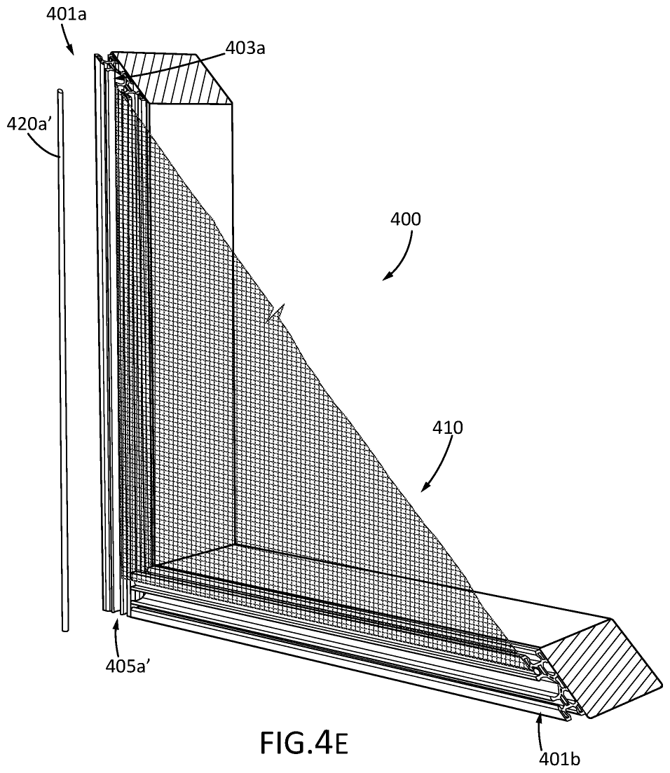

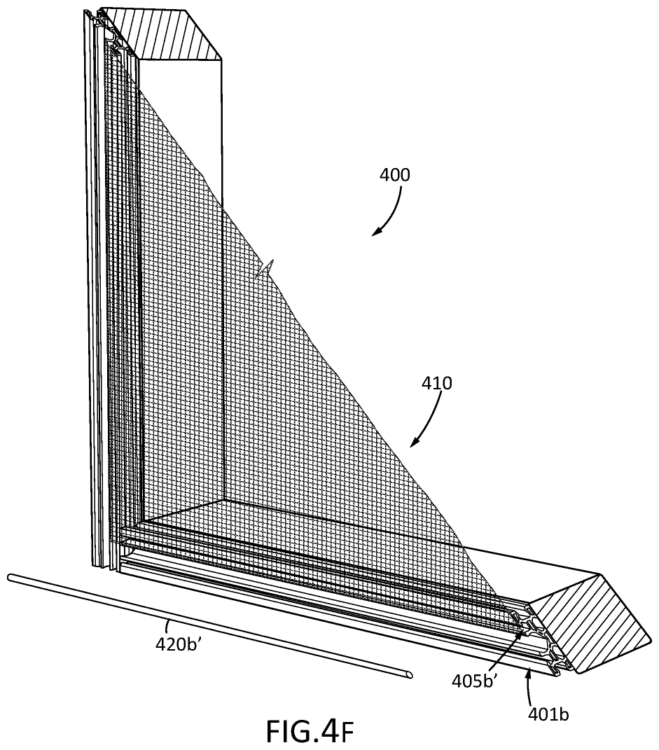

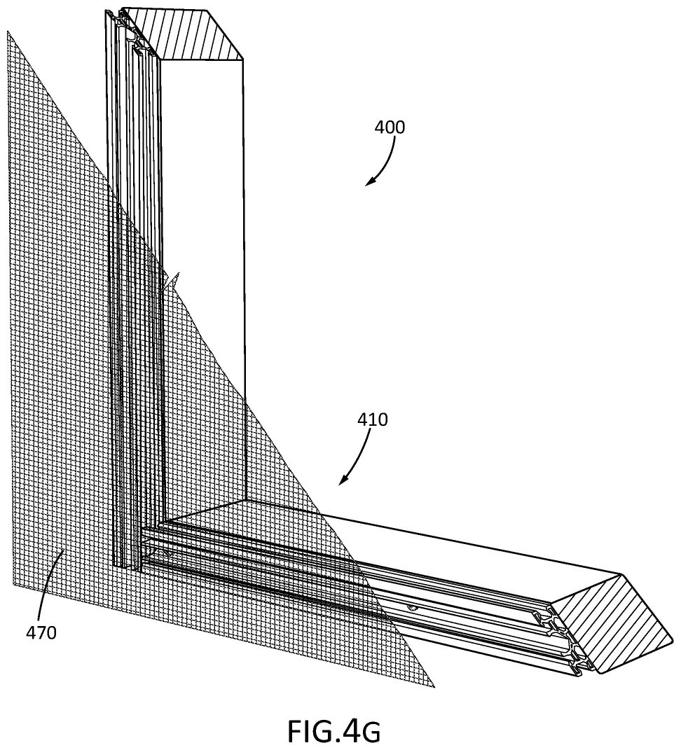

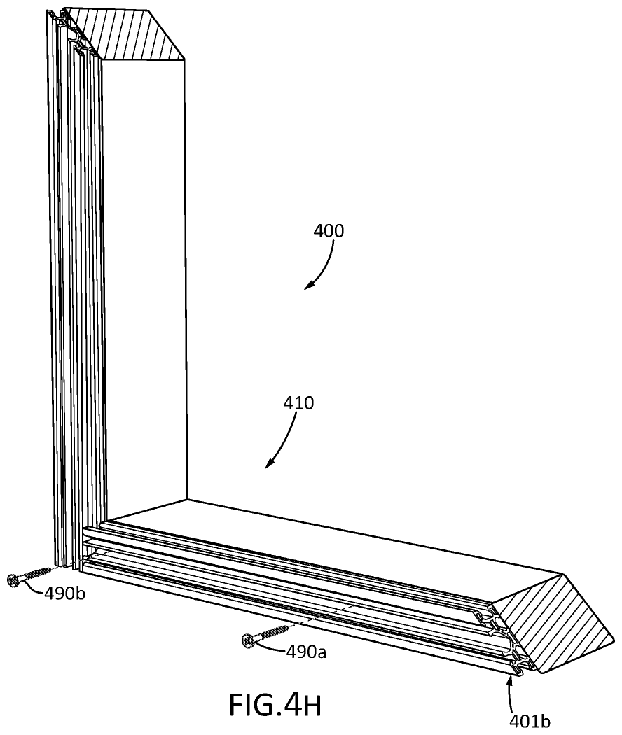

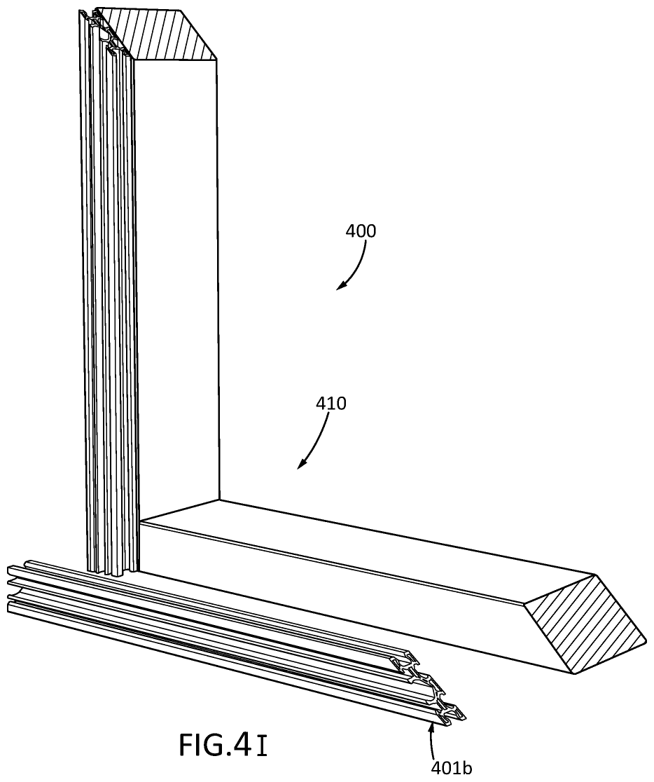

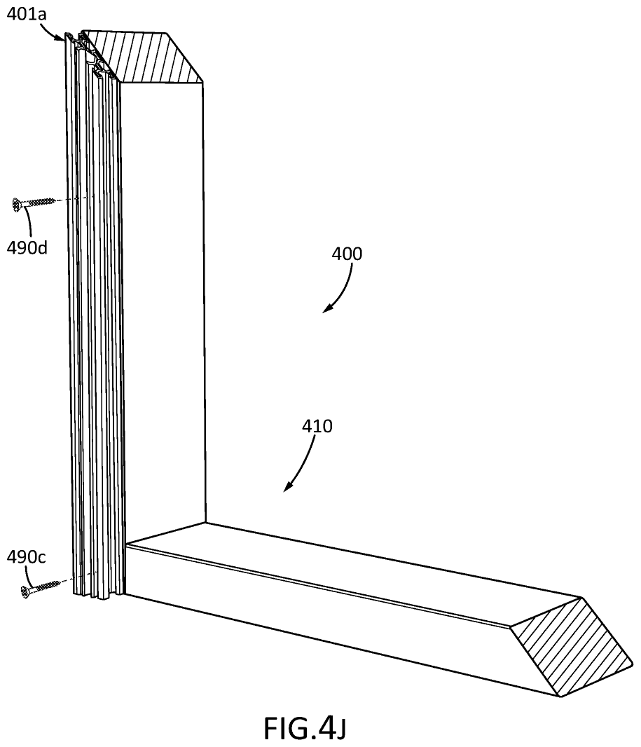

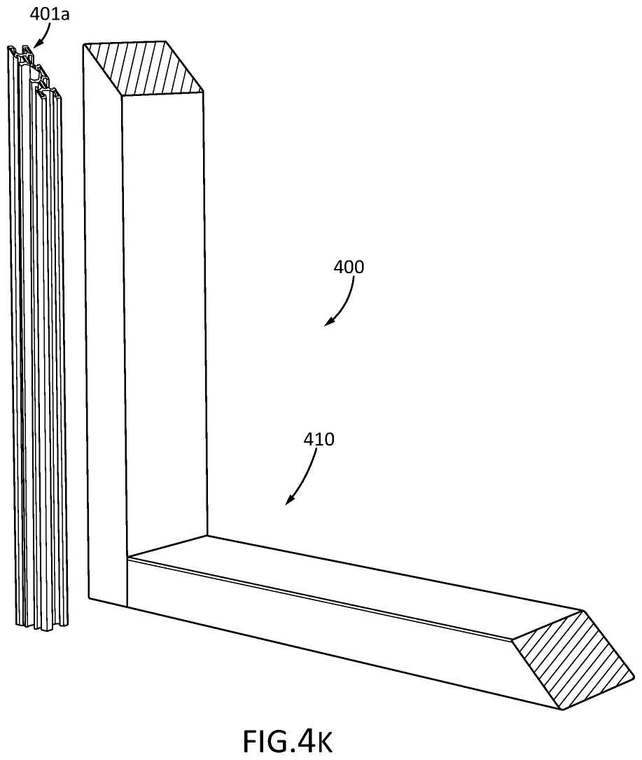

In one aspect, as illustrated, a configurable screen system 200 is shown added to the window frame 14, specifically, a surface-mounted configurable screen system. The configurable screen system 200 includes a surface-mounted track member frame 210, a screen 270, and a plurality of fasteners 290 (best seen in FIGS. 4H and 4J). In particular, the track member frame 210 is made from a first lineal track member 201a, a second lineal track member 201b, a third lineal track member 201c (not shown), and a fourth lineal track member 201d (not shown), each defining a main track 203 (best seen in FIG. 3), an auxiliary track 205 (best seen in FIG. 3), a left side track 207 (best seen in FIG. 3), and a right side track 208 (best seen in FIG. 3), and each having a screen retention member configured as a removable lineal spline 220 (best seen in FIGS. 4E and 4F), a first removable lineal trim piece 240 for the main track 203, and a second removable lineal trim piece 260 for the right side track 209.

FIG. 3 is a cross-sectional view of an illustration of an example lineal track member of an example surface-mounted track member frame of an example configurable screen system with fastener(s), and with a screen added to the track member frame via a removable lineal screen retention member, and taken along line 3-3 of FIG. 2B, according to the present disclosure. More specifically, FIG. 3 shows profile 300 of: (1) a lineal track member 301a; (2) a removable lineal screen retention member configured as a removable lineal spline 320a′ (within a first auxiliary track 305a′); (3) a first removable lineal trim piece 340a for a main track 303a; (4) a second removable lineal trim piece 360a for the right side track 308a; (5) a screen 370; and (6) one fastener 390a of the plurality of fasteners 390. The profile 300 of the lineal track member 301a also shows a second auxiliary track 305a″ and optional installation channel(s) 309a.

In one aspect, each auxiliary track 305a is configured to receive and engage a removable lineal spline 320a, to securely hold a screen edge for the screen 370; however, depending on the intended positioning of the screen 370 relative to the lineal track member 301a for the overall system, only one removable lineal spline 320a and only one auxiliary track 305a (either the first auxiliary track 305a′ or the second auxiliary track 305a″, for example) may be needed. Moreover, in another aspect, each side track 307a, 308a is configured to receive and engage a removable lineal trim piece 360a; however, depending on the intended positioning of the screen 370 relative to the lineal track member 301a for the overall system, only one removable lineal trim piece 360a and only one side track 307a, 308a may be needed. Furthermore, and in particular, each auxiliary track 305a is configured to receive and engage a removable lineal spline 320a via male-female type engagement along the length of the track, and each side track 307a, 308a is configured to receive and engage a removable lineal trim piece 360a via male-female type engagement along the length of the track.

Turning now to FIGS. 4A-4K, FIGS. 4A-4K illustrate step-by-step disassembly of an example surface-mounted track member frame of an example configurable screen system from an example window, according to the present disclosure. First, as illustrated in FIG. 4A, a removable lineal trim piece 460a for the right side track 408a of a first lineal track member 401a is removed from a surface-mounted track member frame 410 of a configurable screen system 400.

Next, as illustrated in FIG. 4B, a removable lineal trim piece 460b for the right side track 408b of a second lineal track member 401b is removed from the surface-mounted track member frame 410 of the configurable screen system 400.

Next, as illustrated in FIG. 4C, a removable lineal trim piece 440b for a main track 403b of the second lineal track member 401b is removed from the surface-mounted track member frame 410 of the configurable screen system 400.

Next, as illustrated in FIG. 4D, a removable lineal trim piece 440a for a main track 403a of the first lineal track member 401a is removed from the surface-mounted track member frame 410 of the configurable screen system 400.

Next, as illustrated in FIG. 4E, a removable lineal spline 420a′ within first auxiliary track 405a′ of the first lineal track member 401a is removed from the surface-mounted track member frame 410 of the configurable screen system 400.

Next, as illustrated in FIG. 4F, a removable lineal spline 420b′ within first auxiliary track 405b′ of the second lineal track member 401b is removed from the surface-mounted track member frame 410 of the configurable screen system 400.

Next, as illustrated in FIG. 4G, a screen 470 is removed from the surface-mounted track member frame 410 of the configurable screen system 400.

Next, as illustrated in FIG. 4H, two fasteners 490a, 490b are removed from the second lineal track member 401b of the surface-mounted track member frame 410 of the configurable screen system 400.

Next, as illustrated in FIG. 4I, the second lineal track member 401b is removed from the surface-mounted track member frame 410 of the configurable screen system 400.

Next, as illustrated in FIG. 4J, two fasteners 490c, 490d are removed from the first lineal track member 401a of the surface-mounted track member frame 410 of the configurable screen system 400.

Next, as illustrated in FIG. 4K, the first lineal track member 401a is removed from the surface-mounted track member frame 410 of the configurable screen system 400.

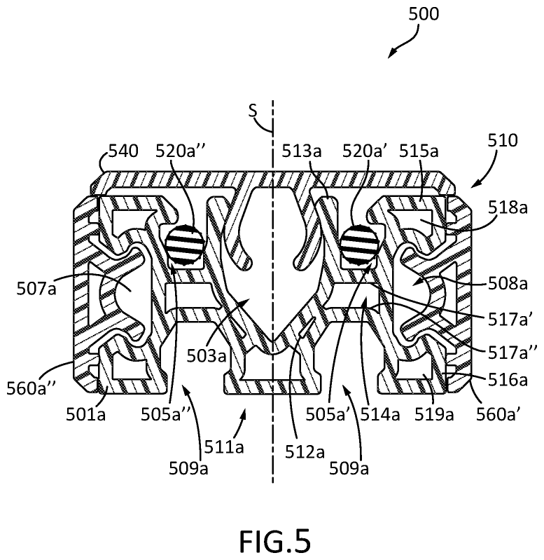

FIG. 5 is a cross-sectional view of an illustration of an example lineal track member of an example surface-mounted track member frame of an example configurable screen system with a screen removed, according to the present disclosure. More specifically, FIG. 5 shows a profile 500 of: (1) a lineal track member 501a; (2) a removable lineal spline 520a′ within a first auxiliary track 505a′; (3) a first removable lineal trim piece 540 for a main track 503a; (4) a second removable lineal trim piece 560a′ for the right side track 508a; (4) an optional removable lineal spline 520a″ within a second auxiliary track 505a″; and (5) and an optional removable lineal trim piece 560a″ for the left side track 507a.

In one aspect, as illustrated, the profile 500 of the lineal track member 501a also includes a first installation channel 509a′ and a second installation channel(s) 509a″. In another aspect, the profile 500 of the lineal track member 501a includes one or more installation channel(s) 509; however; for a surface-mounted track member frame 510, installation channels may not be needed at all.

In one aspect, as illustrated, the profile 500 of the lineal track member 501a has a line of symmetry about the line S and includes: (6) a base portion 511a; (7) an angled wall 512a; (8) a vertical wall 513a; (9) a horizontal portion 514a; (10) a top flange 515a; and (11) a bottom flange 516a. In another aspect, the base portion 511a may be divided by the optional installation channel(s) 509a, and the base portion 511a may be bound on each side by the bottom left and right flanges 516a, for example. In another aspect, the base portion 511a is adjacent to the angled wall 512a leading to the vertical wall 513a and the horizontal portion 514a. In another aspect, as illustrated, the horizontal portion may include one or more horizontal wall(s) 517a (for example, a first horizontal wall 517a′ and a second horizontal wall 517a″) that link the top flange 515a and the bottom flange 516a to the base portion 511a. In another aspect, the top flange 515a may have a hollow interior cavity 518a, or the bottom flange 516a may have a hollow interior cavity 519a, or a combination of both.

In one aspect, as illustrated, the vertical wall 513a, the horizontal portion 514a, and the top flange 515a define the auxiliary track 505a. In another aspect, the base portion 511a, the angled wall 512a, and the vertical wall 513a define the main track 503a. Moreover, in another aspect, the horizontal portion 514a, the top flange 515a, and the bottom flange 516a define the side tracks 507a, 508a. Furthermore, and optionally, in one aspect, the base portion 511a, the horizontal portion 514a, and the bottom flange 516a define the installation channels 509.

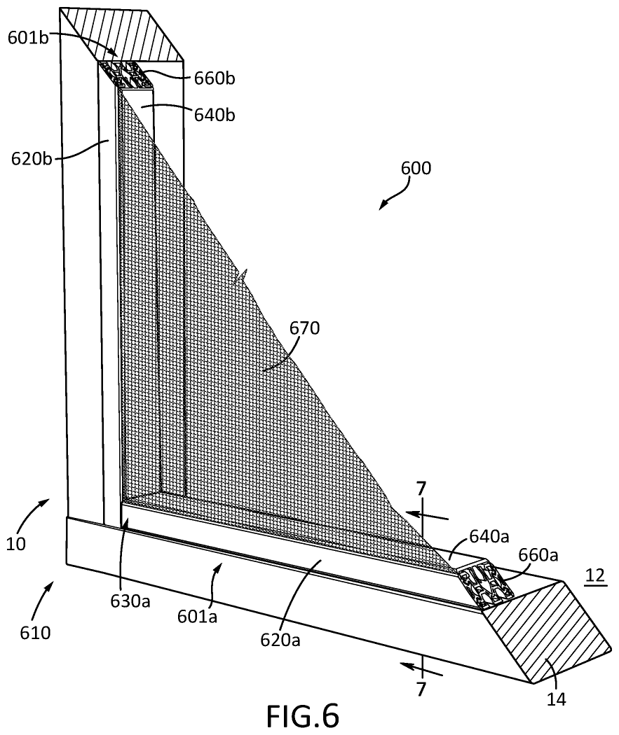

FIG. 6 is a front perspective view of a partial illustration of an example building with an example interior-mounted track member frame of an example configurable screen system added about an example window, according to the present disclosure. In particular, as illustrated, there is shown the corner of a window 10 of a building 12. The window 10 has a window frame 14, in particular, a rectangular window frame, and a window pane (not shown).

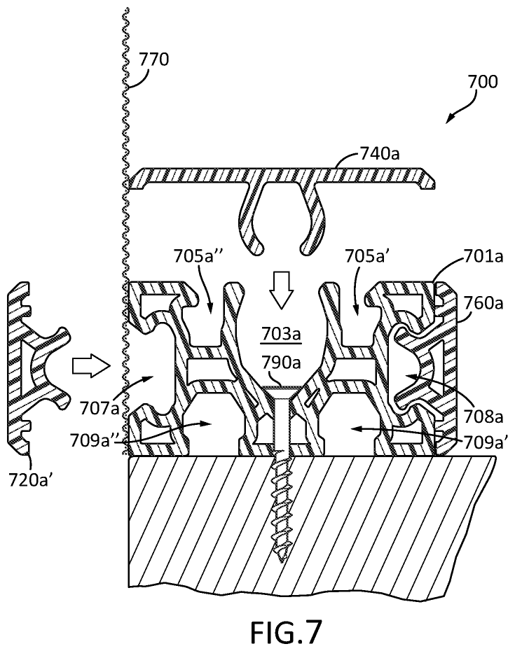

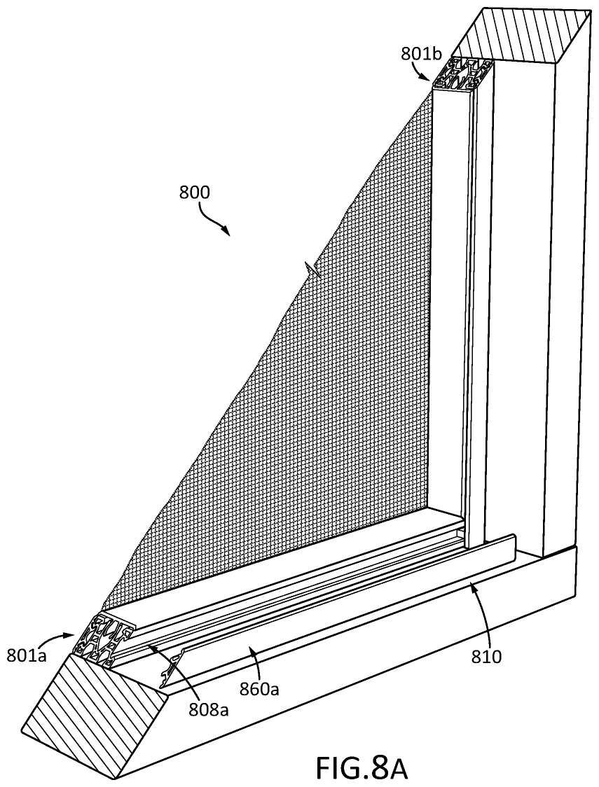

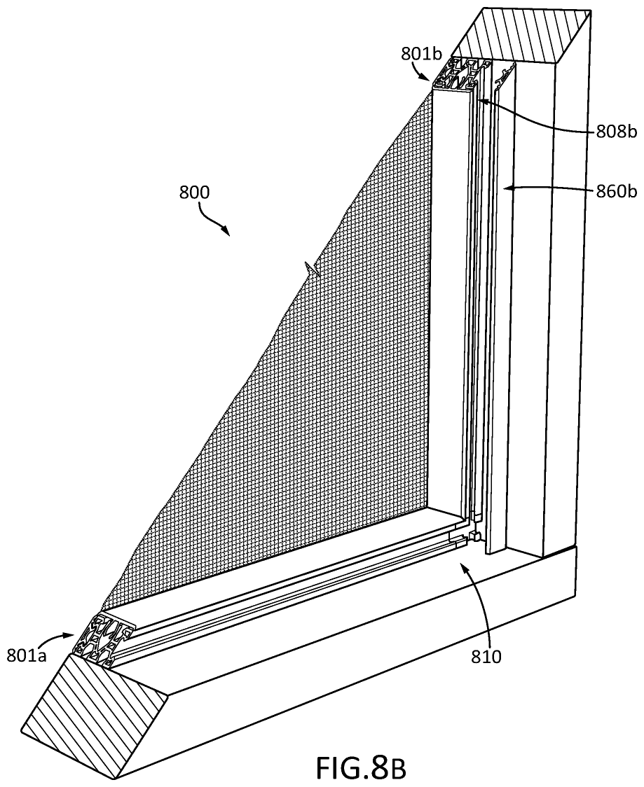

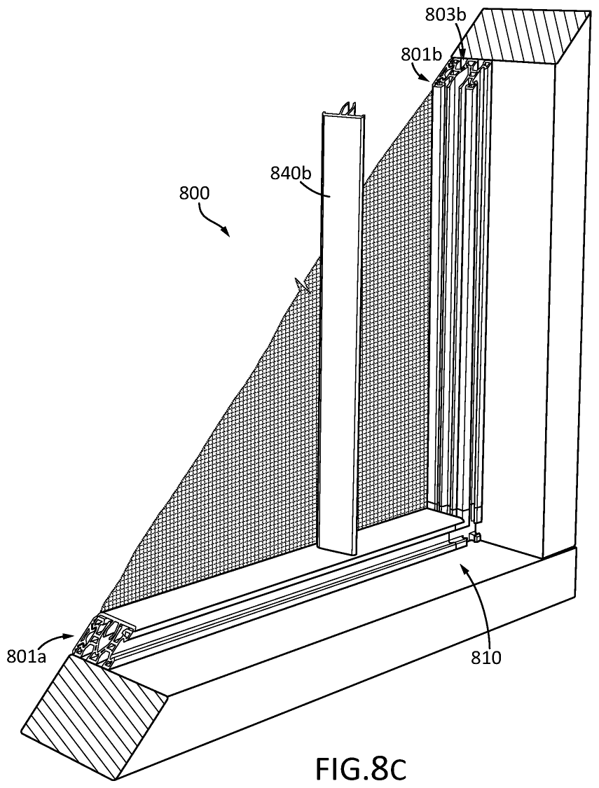

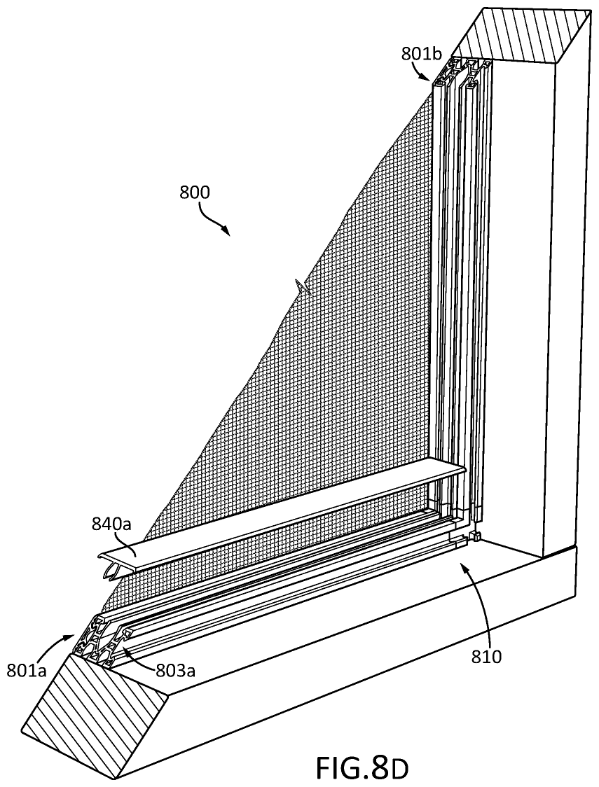

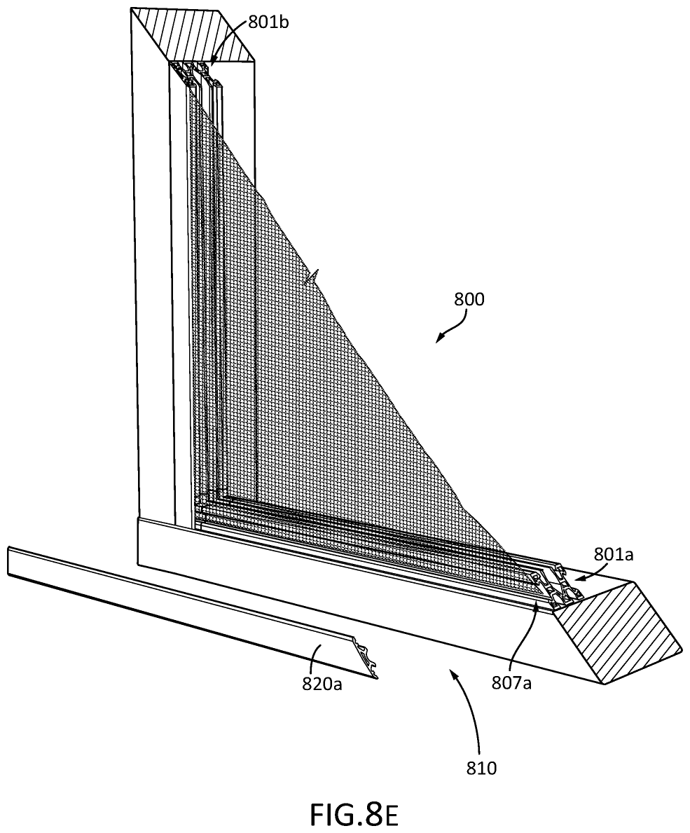

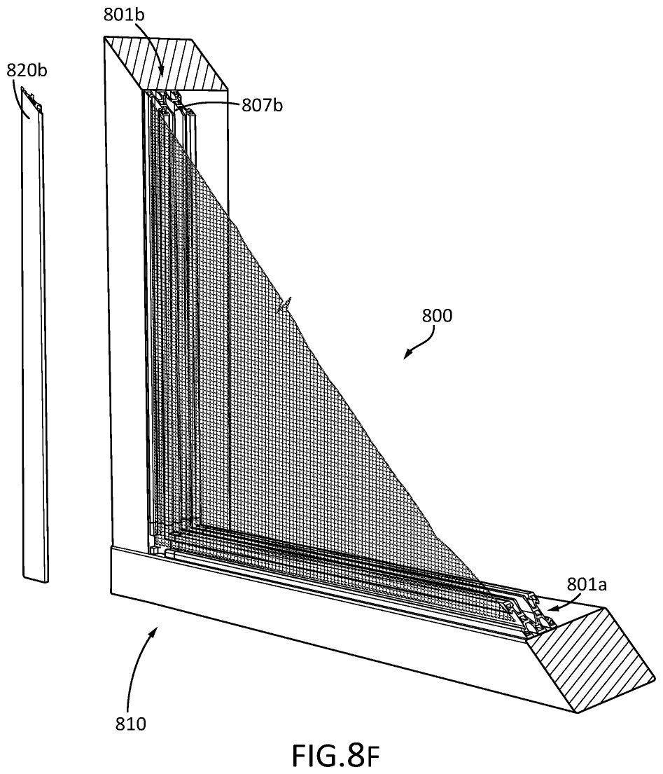

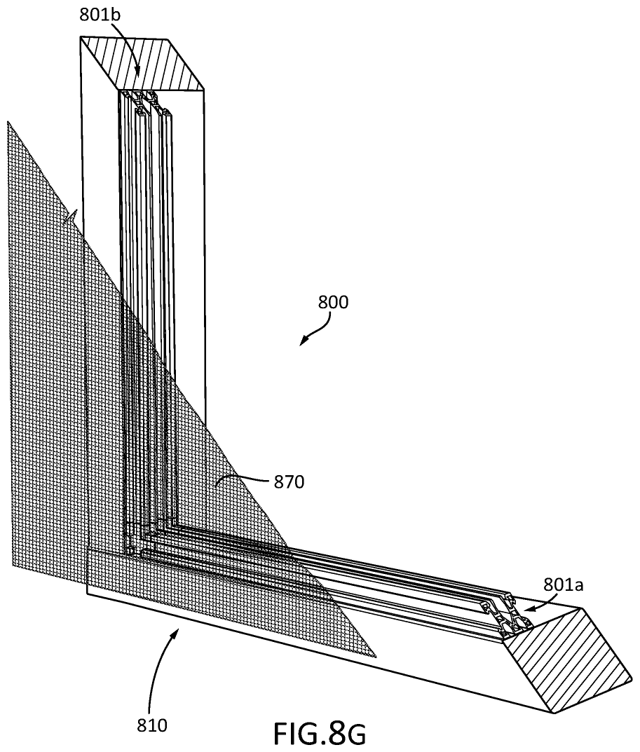

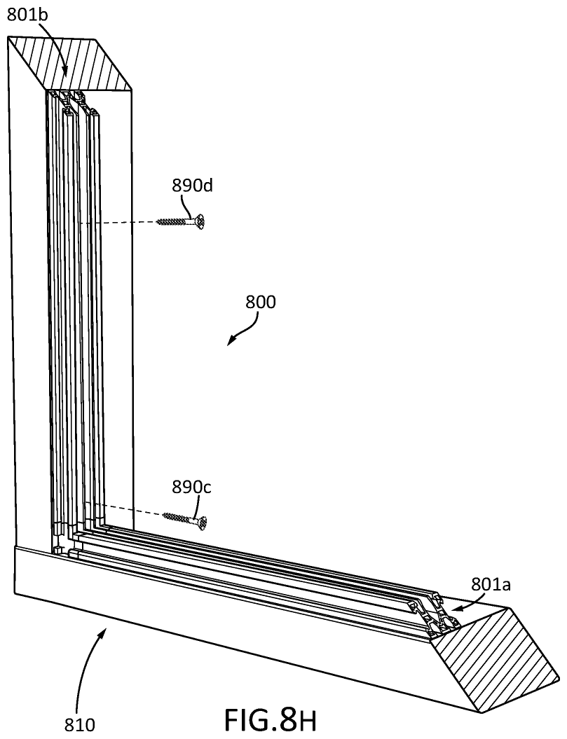

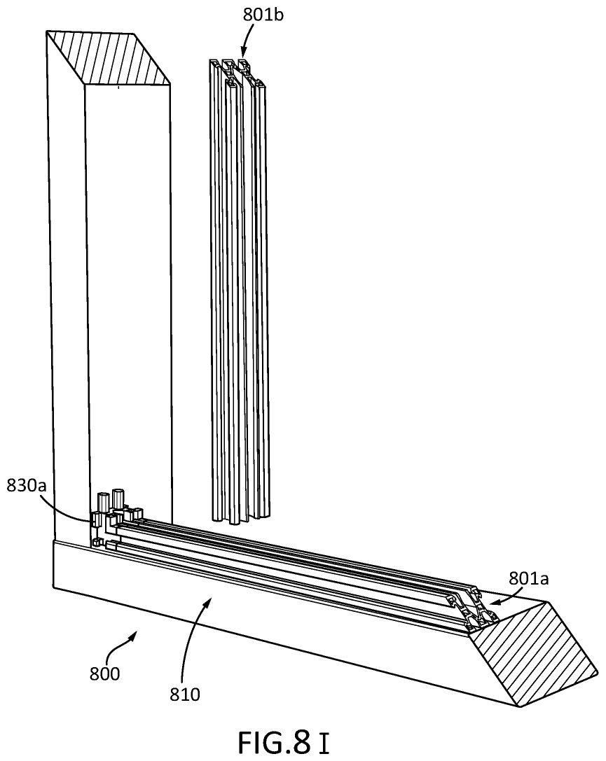

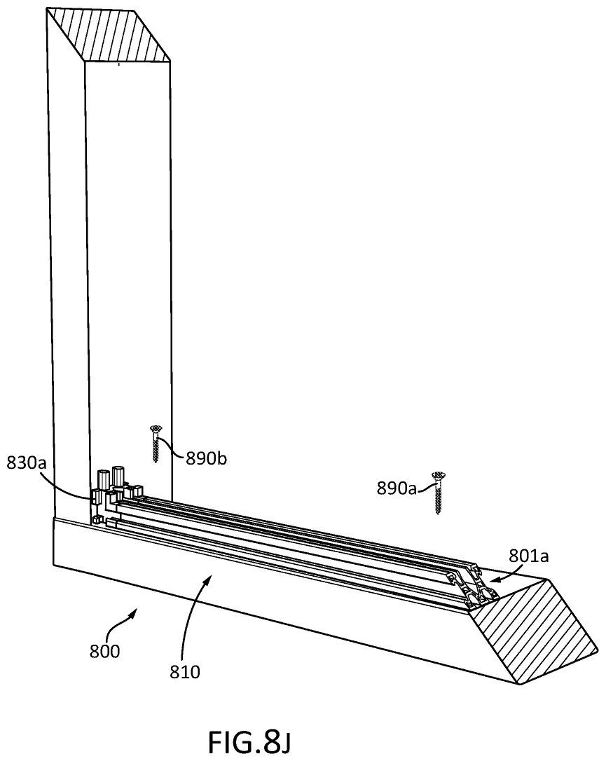

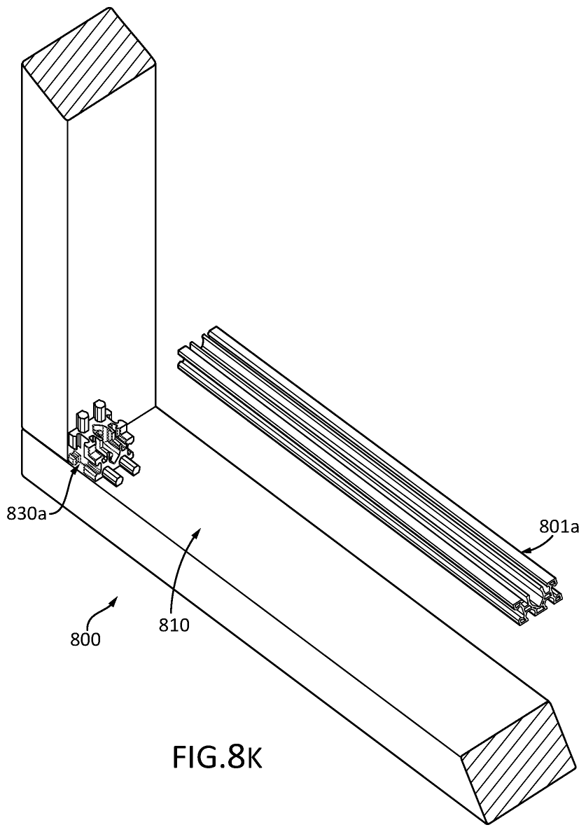

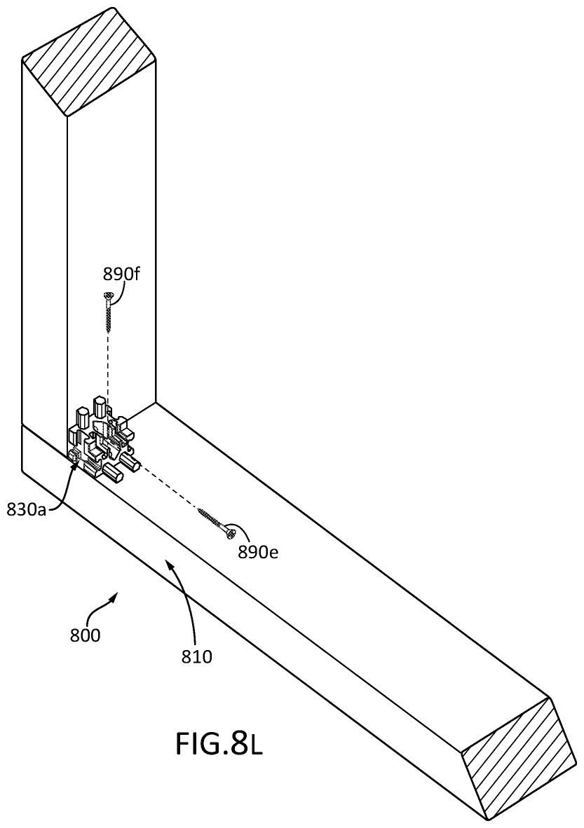

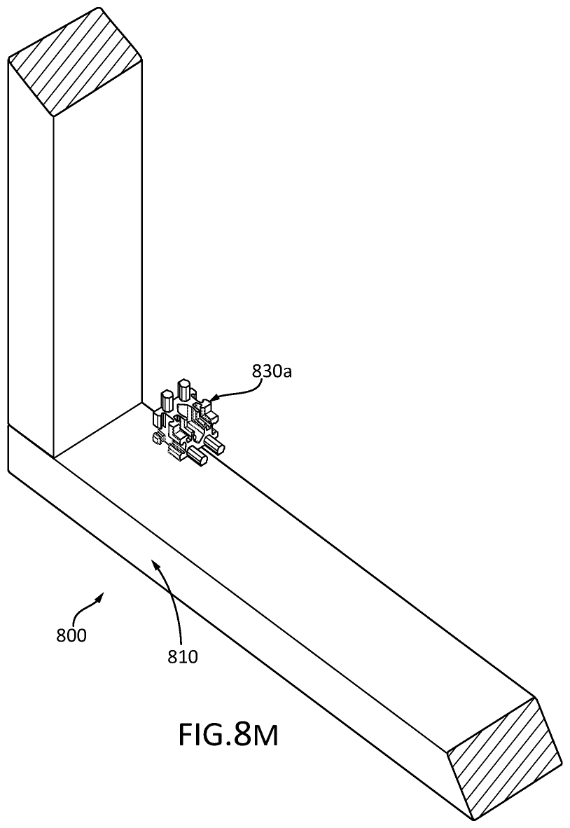

In one aspect, as illustrated, a configurable screen system 600 is shown added to the window frame 14, specifically, an interior-mounted configurable screen system. The configurable screen system 600 includes an interior-mounted track member frame 610, a screen 670, and a plurality of fasteners 690 (best seen in FIGS. 8H, 8J, and 8L). In particular, the track member frame 610 is made from a first lineal track member 601a, a second lineal track member 601b, a third lineal track member 601c (not shown), and a fourth lineal track member 601d (not shown), each defining a main track 603 (best seen in FIG. 7), an auxiliary track 605 (best seen in FIG. 7), a left side track 607 (best seen in FIG. 7), and a right side track 608 (best seen in FIG. 7), and each having a screen retention member configured as a removable lineal screen retention cap 620 for the left side track 607 (best seen in FIGS. 8E and 8F), a first removable lineal trim piece 640 for the main track 603, and a second removable lineal trim piece 660 for the right side track 608. Moreover, as illustrated, the track member frame 610 also is made from a first corner member 630a, a second corner member 630b (not shown), a third corner member 630c (not shown), and a fourth corner member 630d (not shown).

In one aspect, the corner members 630 are configured to link adjacent components of the track member frame 610 such as, for example, the first lineal track member 601a and the second lineal track member 601b (linked by the corner member 630a); the first lineal track member 601a and the third lineal track member 601c (linked by the corner member 630b); the third lineal track member 601c and the fourth lineal track member 601d (linked by the corner member 630c); and the fourth lineal track member 601d and the second lineal track member 601b (linked by the corner member 630d [not shown]). In another aspect, each corner member 630 is configured to engage with the window frame 14 via two fasteners 690e, 690f, wherein a portion of each screw traverses the corner member body 631 through an aperture or hole and a portion is embedded or anchored into the window frame 14. In another aspect, a corner member with an opposite same side corner member also is configured to securely hold a lineal track member in place, for example, the corner member 630a and the corner member 630b are configured to securely hold, in part, the lineal track member 601a.

In another aspect, for a configurable screen system with or without a corner member 630 (see the example of FIGS. 2A and 2B, or the example of FIG. 6), the lineal track member 601 itself is configured to engage with the window frame 14. In particular, in another aspect, the lineal track member 601a engages with the window frame 14 via one or more fasteners 690a, 690b, wherein a portion of each screw extends through and traverses the base portion 611 (not shown) of the lineal track member 601a, through an aperture or hole at various spaced locations along a length of the lineal track member 601a, and a portion is embedded or anchored into the window frame 14. In this way, in one aspect, there are no exposed fasteners 690 as the fasteners 690a, 690b, for example, are recessed and made flush within the main track 603 into the base portion 611 of the lineal track member 601.

As such, in one aspect, when the configurable screen system 600 is added to the window frame 14, for example, as illustrated in FIGS. 6, the fasteners 690 may be inserted anywhere along the lineal track member 601 because its cross section is uniform over that length. If holes have been pre-drilled in the building 12 or the window frame 14, or if anchors have been pre-installed, the fasteners 690 may be inserted into those pre-drilled holes or anchors after traversing the lineal track member 601.

FIG. 7 is a cross-sectional view of an illustration of an example lineal track member of an example interior-mounted track member frame of an example configurable screen system with fastener(s), and with a screen added to the track member frame via a removable lineal screen retention cap, and taken along line 7-7 of FIG. 6, according to the present disclosure. More specifically, FIG. 7 shows profile 700 of: (1) a lineal track member 701a; (2) a removable lineal retention member configured as a removable lineal screen retention cap 720a′ (within a left side track 707a); (3) a first removable lineal trim piece 740 for a main track 703a; (4) a second removable lineal trim piece 760a for the right side track 708a; (5) a screen 770; and (6) one fastener 790a of the plurality of fasteners 790. The profile 700 of the lineal track member 701a also shows a first optional auxiliary track 705a′, a second optional auxiliary track 705a″, a first installation channel 709a′, and a second installation channel 709a″.

In one aspect, each side track 707a, 708a is configured to receive and engage a removable lineal screen retention cap 720a, to securely hold a screen portion for the screen 770; however, depending on the intended positioning of the screen 770 relative to the lineal track member 701a for the overall system, only one removable lineal screen retention cap 720a (either the left side track 707a or the right side track 708a, for example) may be needed. Moreover, in another aspect, each side track 707a, 708a is configured to receive and engage a removable lineal trim piece 760a; however, depending on the intended positioning of the screen 770 relative to the lineal track member 701a for the overall system, the removable lineal trim piece 760a may be needed only on one side. Furthermore, and in one particular aspect, each side track 707a, 708a is configured to receive and engage the removable lineal screen retention cap 720a via male-female type engagement along the length of the track, and each side track 707a, 708a is configured to receive and engage the removable lineal trim piece 760a via male-female type engagement along the length of the track. In another aspect, the removable lineal screen retention cap 720a′, and the first removable lineal cap member 740a, and/or the second removable lineal trim piece 760a includes two legs for a press-fit, a snap-fit, and/or a friction fit engagement to the lineal track member 701a. The two legs, in another aspect, may project out and allow for some bending to facilitate the press-fit or snap-fit or friction-fit type engagement.

Turning now to FIGS. 8A-8M, FIGS. 8A-8M illustrate step-by-step disassembly of an example interior-mounted track member frame of an example configurable screen system from an example window, according to the present disclosure. First, as illustrated in FIG. 8A, a removable lineal trim piece 860a for the right side track 808a of a first lineal track member 801a is removed from an interior-mounted track member frame 810 of a configurable screen system 800.

Next, as illustrated in FIG. 8B, a removable lineal trim piece 860b for the right side track 808b of a second lineal track member 801b is removed from the interior-mounted track member frame 810 of the configurable screen system 800.

Next, as illustrated in FIG. 8C, a removable lineal trim piece 840b for a main track 803b of the second lineal track member 801b is removed from the interior-mounted track member frame 810 of the configurable screen system 800.

Next, as illustrated in FIG. 8D, a removable lineal trim piece 840a for a main track 803a of the first lineal track member 801a is removed from the interior-mounted track member frame 810 of the configurable screen system 800.

Next, as illustrated in FIG. 8E, a removable lineal screen retention cap 820a for the left side track 807a of a first lineal track member 801a is removed from the interior-mounted track member frame 810 of a configurable screen system 800.

Next, as illustrated in FIG. 8F, a removable lineal screen retention cap 820b for the left side track 807b of a second lineal track member 801b is removed from the interior-mounted track member frame 810 of a configurable screen system 800.

Next, as illustrated in FIG. 8G, a screen 870 is removed from the interior-mounted track member frame 810 of the configurable screen system 800.

Next, as illustrated in FIG. 8H, two fasteners 890c, 890d are removed from the second lineal track member 801b of the interior-mounted track member frame 810 of the configurable screen system 800.

Next, as illustrated in FIG. 8I, the second lineal track member 801b is removed from the interior-mounted track member frame 810 of the configurable screen system 800.

Next, as illustrated in FIG. 8J, two fasteners 890a, 890b are removed from the first lineal track member 801a of the interior-mounted track member frame 810 of the configurable screen system 800.

Next, as illustrated in FIG. 8K, the first lineal track member 801a is removed from the interior-mounted track member frame 810 of the configurable screen system 800.

Next, as illustrated in FIG. 8L, two fasteners 890e, 890f are removed from the first corner member 830a of the interior-mounted track member frame 810 of the configurable screen system 800.

Next, as illustrated in FIG. 8M, the first corner member 830a of the interior-mounted track member frame 810 of the configurable screen system 800 is removed leaving the window frame 14.

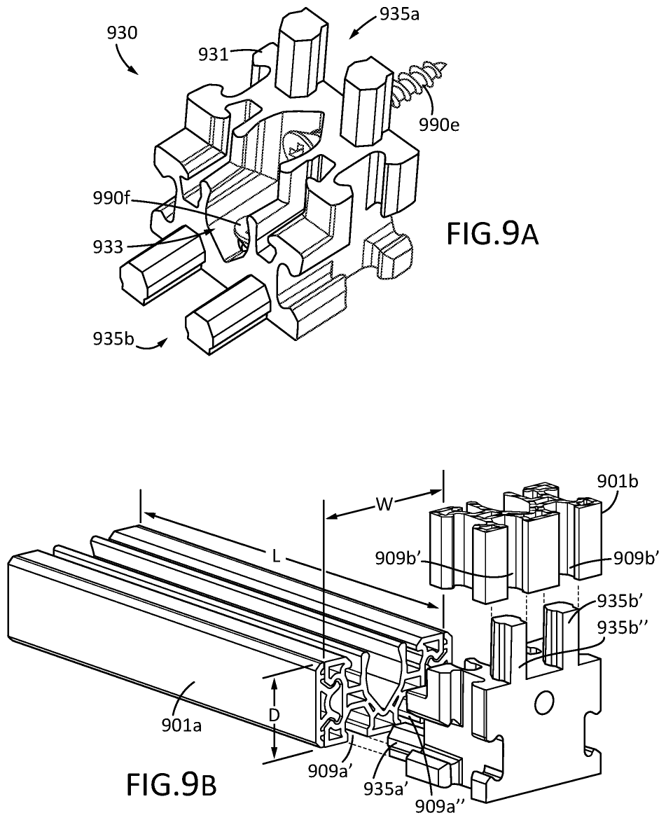

Turning now to FIGS. 9A-9B, FIG. 9A is a front perspective view of an illustration of an example corner member of an interior-mounted track member frame of an example configurable screen system, according to the present disclosure; and FIG. 9B is an exploded rear perspective view of an illustration of an example corner member and two adjacent lineal track members (not shown) of the interior-mounted track member frame of the configurable screen system, according to the present disclosure. In particular, each lineal track member 901 has a length, L, a depth, D, and a width., W, and the tracks defined thereby run parallel to the length and perpendicular to the depth.

In one aspect, as illustrated, a corner member 930 includes a corner member body 931. The corner member 930, in another aspect, is configured to engage with an underlying substrate like, for example, a window frame. In particular, in another aspect, the corner member body 931 engages with the underlying substrate via one or more fasteners 990e, 990f (not shown), wherein a portion of each screw extends through and traverses the corner member body 931 through an aperture or hole to allow a portion to be embedded or anchored into the underlying substrate. In another aspect, fastener 990e is perpendicular to fastener 990f (not shown). Moreover, in another aspect, there are no exposed fasteners 990e, 990f as the fasteners for the corner member 930, for example, are recessed and made flush within a corner track 933 of the corner member 930 of a track member frame 910 (not shown). In this way, in another aspect, as the corner members 930 is configured to link adjacent lineal track members 901a, 901b, the result is that the corner track 933 links the main tracks 903a, 903b (not shown) of the two adjacent lineal track members (not shown) and forms a corner for the main track 903 (not shown) of the track member frame 910 (not shown).

In one aspect, the corner member 930 also includes connection prong(s) 935a, 935b corresponding to the installation channel(s) 909 (not shown) of each of the two adjacent lineal track members (not shown) forming the corner of the track member frame 910 (not shown). As such, each installation channel 909 is configured to receive and engage a connection prong 935 via male-female type engagement at each end of each lineal track member 901, for example.

In one aspect, as illustrated in FIG. 9B specifically, the corner member 930 includes connection prongs 935a, 935b, wherein a connection prong 935a′ corresponds to a first installation channel 909a′, wherein a connection prong 935a″ corresponds to a second installation channel(s) 909a″, wherein a connection prong 935b′ corresponds to a first installation channel 909b′, and wherein a connection prong 935b″ corresponds to a second installation channel 909b″. As such, in another aspect, the lineal track member 901a, at one end, is configured to receive and engage the connection prongs 935a via male-female type engagement, for example. Moreover, in another aspect, the lineal track member 901b, at one end, is configured to receive and engage the connection prongs 935b via male-female type engagement, for example.

In one aspect, not illustrated, each lineal track member 901 is configured to slide into engagement, at one end, with an installed corner member 930a and to have a pre-positioned corner member 930b in position (e.g. engaged), at the other end, for installation once the lineal track member 901 is engaged to the corner member 930a and in place on a substrate, for example. In another aspect, not illustrated, each lineal track member 901 is configured to slide into engagement, at one end, with an installed corner member 930a and to snap onto the connection prong(s) 935 of an installed corner member 930b, for example. In another aspect, not illustrated, each lineal track member 901 is configured, at one end, to snap onto the connection prongs 935a of an installed corner member 930a, and configured, at the other end, to snap onto the connection prong(s) 935 of an installed corner member 930b, for example.

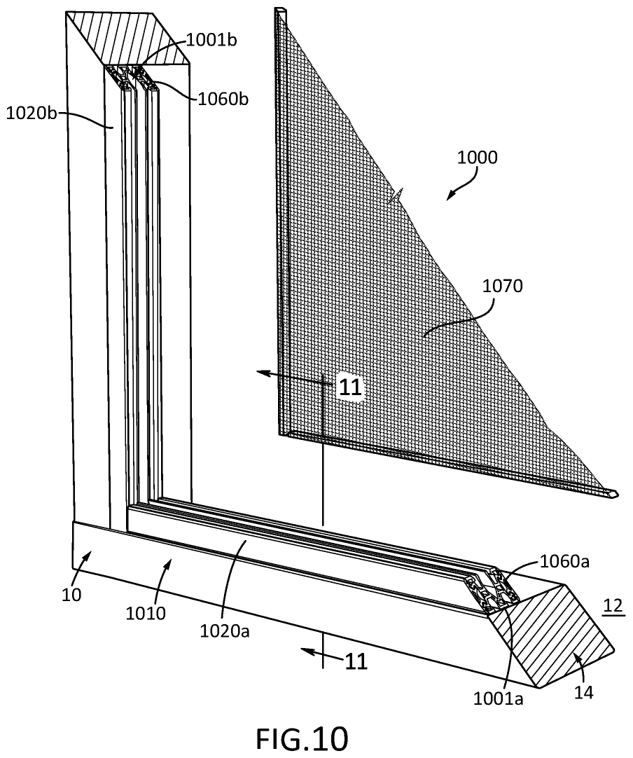

FIG. 10 is a front perspective view of a partial illustration of an example building with an example interior-mounted track member frame with a flexible screen panel of an example configurable multi-track sheet system added about an example window, according to the present disclosure. In particular, as illustrated, there is shown the corner of a window 10 of a building 12. The window 10 has a window frame 14, in particular, a rectangular window frame, and a window pane (not shown).

In one aspect, as illustrated, an interior-mounted configurable screen system 1000 is shown added to the window frame 14. The configurable multi-track sheet system 1000 includes an interior-mounted track member frame 1010, a flexible screen panel with flexible frame 1070, and a plurality of fasteners 1090 (not shown). In particular, the track member frame 1010 is similar to the track member frame 610 of FIG. 6, except for the following detailed differences.

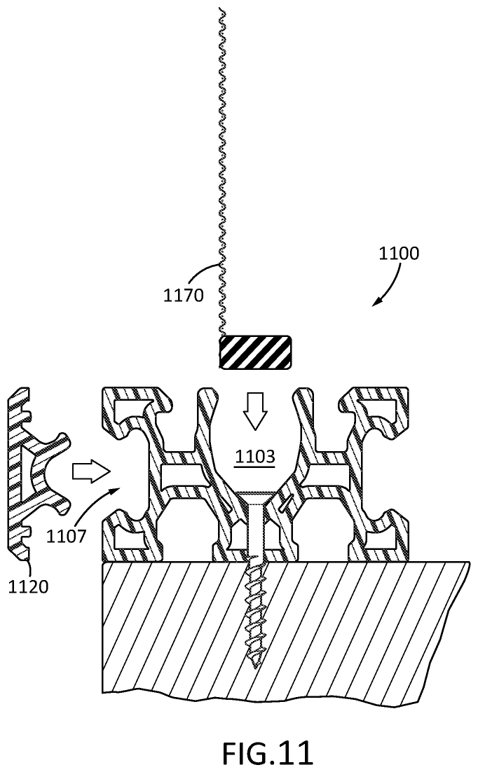

In one aspect, as illustrated, the interior-mounted track member frame 1010 does not require a removable lineal screen retention cap for the left side track 1007 (best seen in FIG. 11) or a removal lineal trim piece for the main track 1003 (best seen in FIG. 11); instead, the interior-mounted track member frame 1010 has a removable lineal trim piece 1020 for the left side track 1007 and a removable lineal trim piece 1060 for the right side track 1008. Moreover, in another aspect, as corner members 1030 are configured to link two adjacent lineal track members 1001a, 1001b, the result is a main track 1003 of the track member frame 1010 that is configured to receive the flexible screen panel with flexible frame 1070.

FIG. 11 is a cross-sectional view of an illustration of an example lineal track member of an example interior-mounted track member frame with a flexible screen panel of an example configurable screen system, taken along line 11-11 of FIG. 10, according to the present disclosure. In particular, profile 1100 of FIG. 11 is similar to the profile 700 of FIG. 7, except for the following detailed differences.

In one aspect, as illustrated, FIG. 11 shows profile 1100 having a flexible screen panel with flexible frame 1170 within the main track 1103. In another aspect, as illustrated, the profile 1100 includes a removable lineal trim piece 1120 for the left side track 1107.

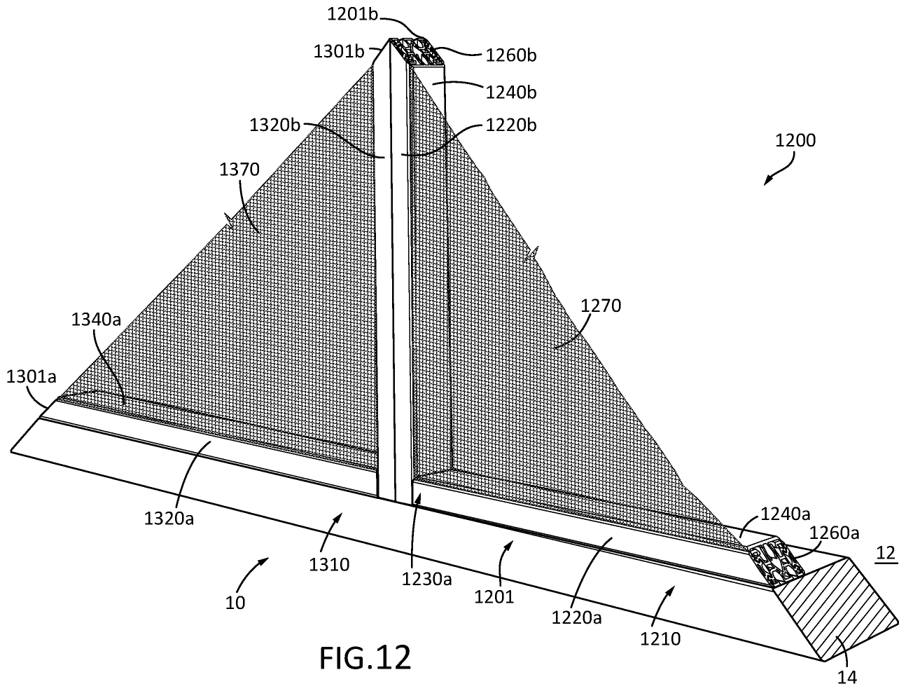

FIG. 12 is a front perspective view of a partial illustration of an example porch with two example interior-mounted track member frames each with a flexible screen panel added about an example window, according to the present disclosure. In particular, as illustrated, there is shown the middle of a window 10 of a porch 12. The window 10 has a window frame 14 (partial; only the horizontal portion is shown), in particular, a rectangular window frame, and a window pane (not shown). Moreover, each of the two interior-mounted track member frames 1210, 1310 has a plurality of lineal track members 1201, 1301, and the lineal track member 1201b, 1301b are engaged, back-to-back, forming a mullion type structure. In particular, each of the two interior-mounted track member frames 1210, 1310 is similar to the track member frame 610 of FIG. 6, except for the following detailed differences.

In one aspect, for example, the lineal track member 1201b is configured to slide into engagement, at one end, with an installed corner member (not shown; along the window frame 14) and to have a pre-positioned corner member (not shown) in position (e.g. engaged), at the other end, for installation onto the adjacent lineal track member 1301b as the mullion is built up/constructed (vertically). In another aspect, for example, the lineal track member 1201b is configured to slide into engagement, at one end, with an installed corner member (not shown; along the window frame 14) and to snap onto the connection prong(s) (not shown) of an installed corner member (not shown; installed on the adjacent lineal track member 1301b). In another aspect, for example, the lineal track member 1201b is configured, at one end, to snap onto the connection prongs of an installed corner member (not shown, along the window frame 14), and configured, at the other end, to snap onto the connection prong(s) of an installed corner member (not shown; installed on the adjacent lineal track member 1301b). In another aspect, for example, the lineal track member 1201b is configured to slide into or to snap into engagement, at one end, with an installed corner member (not shown; along one horizontal side of the window frame 14) and to have a pre-positioned corner member (not shown) in position (e.g. engaged), at the other end, for installation onto the window frame 14 (not shown; along the other horizontal side of the window frame 14). In another aspect, for example, the lineal track member 1201b is configured to slide into or to snap into engagement, at one end, with an installed corner member (not shown; along one horizontal side of the window frame 14) and to snap into engagement, at the other end, with an installed corner member (not shown; along the other horizontal side of the window frame 14). The preceding paragraph is applicable to the lineal track member 1201a, and 1301a, or course, as it relates to the horizontal orientation of the lineal track member 1201a, and 1301a (no horizontal mullion type structure is shown; however, it is within the scope of this disclosure).

In one aspect, as illustrated, each interior-mounted track member frame 1210, 1310 has a corresponding flexible screen panel 1270, 1370, and a plurality of fasteners 1290, 1390 (not shown). In another aspect, each lineal track member 1201, 1301 has a screen retention member configured as a removable lineal screen retention cap 1220 for the left side track (not shown), a first removable lineal trim piece 1240 for the main track (not shown), and a second removable lineal trim piece 1260 for the right side track (not shown). In another aspect, if the interior-mounted track member frame 1210, 1310 has a second flexible sheet like structure (e.g. a flexible plastic sheet, a flexible glass sheet, a flexible impact resistant sheet, etc. forming an isolated gap with the screen 1270, 1370, for example), then each lineal track member 1201, 1301 includes a removable lineal screen retention cap 1260 for the right side track (not shown) instead of the lineal trim piece. In further aspects, a rigid screen is installed within the track, or a polymeric sheet, or a semi-flexible glass panel, all of which may fit into the lineal track member 1201, 1301.

### IV. EMBODIMENTS

Certain implementations of systems and methods consistent with the present disclosure are provided as follows:
Clause 1. A configurable multi-track sheet system for an opening in a building, comprising: (a) a lineal track member having a length and a depth, and defining a main track and an auxiliary track each running parallel to the length and perpendicular to the depth, and defining a first side track opposite a second side track each running parallel to the length and perpendicular to the depth; (b) a removable lineal sheet retention member configured to be engaged, at least in part, by the lineal track member, via male-female type engagement, along at least a portion of: (i) the main track; (ii) the auxiliary track; (iii) the first side track; or (iv) the second side track, and (c) a first removable lineal cap member being attachable to the lineal track member, via male-female type engagement, for covering: (i) the main track and the auxiliary track; (ii) the first side track; or (iii) the second side track, wherein the first removable lineal cap member comprises two legs for attaching to the lineal track member.
Clause 2. The configurable multi-track sheet system of clause 1, further comprising: (d) a corner member configured to engage with a substrate via one or more screws, and configured to link two adjacent lineal track members.
Clause 3. The configurable multi-track sheet system of clause 1: wherein the removable lineal sheet retention member is a lineal spline configured to be engaged by the auxiliary track; and wherein the first removable lineal cap member is a first removable lineal trim piece for covering the main track and the auxiliary track.
Clause 4. The configurable multi-track sheet system of clause 1: wherein the removable lineal sheet retention member is a lineal spline configured to be engaged by the auxiliary track; and wherein the first removable lineal cap member is a first removable lineal trim piece for covering the first side track.
Clause 5. The configurable multi-track sheet system of clause 1: wherein the removable lineal sheet retention member is a lineal spline configured to be engaged by the auxiliary track; and wherein the first removable lineal cap member is a first removable lineal trim piece for covering the second side track.
Clause 6. The configurable multi-track sheet system of clause 1: wherein the removable lineal sheet retention member is a second removable lineal cap configured to be engaged by the first side track; and wherein the first removable lineal cap member is a first removable lineal trim piece for covering the main track and the auxiliary track.
Clause 7. The configurable multi-track sheet system of clause 6, further comprising a second removable lineal trim piece for covering the second side track.
Clause 8. The configurable multi-track sheet system of clause 1: wherein the removable lineal sheet retention member is a second removable lineal cap configured to be engaged by the first side track; and wherein the first removable lineal cap member is a first removable lineal trim piece for covering the second side track.
Clause 9. The configurable multi-track sheet system of clause 8, further comprising a second removable lineal trim piece for covering the main track and the auxiliary track.
Clause 10. The configurable multi-track sheet system of clause 1: wherein the removable lineal sheet retention member is a second removable lineal cap configured to be engaged by the second side track; and wherein the first removable lineal cap member is a first removable lineal trim piece for covering the main track and the auxiliary track.
Clause 11. The configurable multi-track sheet system of clause 10, further comprising a second removable lineal trim piece for covering the first side track.
Clause 12. The configurable multi-track sheet system of clause 1: wherein the removable lineal sheet retention member is a second removable lineal cap configured to be engaged by the second side track; and wherein the first removable lineal cap member is a first removable lineal trim piece for covering the first side track.
Clause 13. The configurable multi-track sheet system of clause 12, further comprising a second removable lineal trim piece for covering the main track and the auxiliary track.
Clause 14. A configurable multi-track sheet system for an opening in a building, comprising: (a) a lineal track member having a length and a depth, and defining a main track and an auxiliary track each running parallel to the length and perpendicular to the depth, and defining a first side track opposite a second side track each running parallel to the length and perpendicular to the depth; (b) a corner member configured to link two adjacent lineal track members; (c) a removable lineal sheet retention cap configured to be engaged, at least in part, by the lineal track member, via male-female type engagement, along at least a portion of: (i) the first side track; or (ii) the second side track, and (c) a first removable lineal trim piece being attachable to the lineal track member, via male-female type engagement, for covering: (i) the main track and the auxiliary track; (ii) the first side track; or (iii) the second side track, wherein the first removable lineal trim piece comprises two legs for attaching to the lineal track member.
Clause 15. The configurable multi-track sheet system of clause 14: further comprising a second removable lineal trim piece, and wherein the removable lineal sheet retention cap is configured to be engaged by the first side track; wherein the first removable lineal trim piece is for covering the main track and the auxiliary track, and wherein the second removable lineal trim piece is for covering the second side track.
Clause 16. The configurable multi-track sheet system of clause 14: further comprise a second removable lineal trim piece, and wherein the removable lineal sheet retention cap is configured to be engaged by the first side track; wherein the first removable lineal trim piece is for covering the second side track; and wherein the second removable lineal trim piece is for covering the main track and the auxiliary track.
Clause 17. The configurable multi-track sheet system of clause 14: further comprising a second removable lineal trim piece, and wherein the second removable lineal trim piece is configured to be engaged by the second side track; wherein the first removable lineal trim piece is for covering the main track and the auxiliary track; and wherein the second removable lineal trim piece for covering the first side track.
Clause 18. The configurable multi-track sheet system of clause 14: further comprising a second removable lineal trim piece, and wherein the second removable lineal trim piece is configured to be engaged by the second side track; wherein the first removable lineal trim piece is for covering the first side track; and wherein the second removable lineal trim piece is for covering the main track and the auxiliary track.
Clause 19. A method of using a configurable multi-track sheet system, the method comprising: (a) providing a lineal track member having a length and a depth, the lineal track member defining a main track and an auxiliary track each running parallel to the length and perpendicular to the depth, and defining a first side track opposite a second side track each running parallel to the length and perpendicular to the depth; (b) providing a removable lineal sheet retention member configured to be engaged, at least in part, by the lineal track member, via male-female type engagement, along at least a portion of: (i) the main track; (ii) the auxiliary track; (iii) the first side track; or (iv) the second side track, and (c) providing a first removable lineal cap member being attachable to the lineal track member, via male-female type engagement, for covering: (i) the main track and the auxiliary track; (ii) the first side track; or (iii) the second side track.
Clause 20. The method of clause 19, further comprising installing the lineal track member onto a substrate via a corner member of the configurable multi-track sheet system that is anchored onto the substrate, or via one or more fasteners extending through the lineal track member and into the substrate, or via a combination of both.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. A configurable multi-track sheet system for an opening in a building, comprising:
(a) a lineal track member having a length and a depth, and defining a main track and an auxiliary track each running parallel to the length and perpendicular to the depth, and defining a first side track opposite a second side track each running parallel to the length and perpendicular to the depth;
(b) a removable lineal sheet retention member configured to be engaged, at least in part, by the lineal track member, via male-female type engagement, along at least a portion of:
(i) the main track;
(ii) the auxiliary track;
(iii) the first side track; or
(iv) the second side track, and
(c) a first removable lineal cap member being attachable to the lineal track member, via male-female type engagement, for covering:
(i) the main track and the auxiliary track;
(ii) the first side track; or
(iii) the second side track,
wherein the first removable lineal cap member comprises two legs for attaching to the lineal track member.

2. The configurable multi-track sheet system of claim 1, further comprising:
(d) a corner member configured to engage with a substrate via one or more screws, and configured to link two adjacent lineal track members.

3. The configurable multi-track sheet system of claim 1:
wherein the removable lineal sheet retention member is a lineal spline configured to be engaged by the auxiliary track; and
wherein the first removable lineal cap member is a first removable lineal trim piece for covering the main track and the auxiliary track.

4. The configurable multi-track sheet system of claim 1:
wherein the removable lineal sheet retention member is a lineal spline configured to be engaged by the auxiliary track; and
wherein the first removable lineal cap member is a first removable lineal trim piece for covering the first side track.

5. The configurable multi-track sheet system of claim 1:
wherein the removable lineal sheet retention member is a lineal spline configured to be engaged by the auxiliary track; and
wherein the first removable lineal cap member is a first removable lineal trim piece for covering the second side track.

6. The configurable multi-track sheet system of claim 1:
wherein the removable lineal sheet retention member is a second removable lineal cap configured to be engaged by the first side track; and
wherein the first removable lineal cap member is a first removable lineal trim piece for covering the main track and the auxiliary track.

7. The configurable multi-track sheet system of claim 6, further comprising a second removable lineal trim piece for covering the second side track.

8. The configurable multi-track sheet system of claim 1:
wherein the removable lineal sheet retention member is a second removable lineal cap configured to be engaged by the first side track; and
wherein the first removable lineal cap member is a first removable lineal trim piece for covering the second side track.

9. The configurable multi-track sheet system of claim 8, further comprising a second removable lineal trim piece for covering the main track and the auxiliary track.

10. The configurable multi-track sheet system of claim 1:
wherein the removable lineal sheet retention member is a second removable lineal cap configured to be engaged by the second side track; and
wherein the first removable lineal cap member is a first removable lineal trim piece for covering the main track and the auxiliary track.

11. The configurable multi-track sheet system of claim 10, further comprising a second removable lineal trim piece for covering the first side track.

12. The configurable multi-track sheet system of claim 1:
wherein the removable lineal sheet retention member is a second removable lineal cap configured to be engaged by the second side track; and
wherein the first removable lineal cap member is a first removable lineal trim piece for covering the first side track.

13. The configurable multi-track sheet system of claim 12, further comprising a second removable lineal trim piece for covering the main track and the auxiliary track.

14. A configurable multi-track sheet system for an opening in a building, comprising:
(a) a lineal track member having a length and a depth, and defining a main track and an auxiliary track each running parallel to the length and perpendicular to the depth, and defining a first side track opposite a second side track each running parallel to the length and perpendicular to the depth;
(b) a corner member configured to link two adjacent lineal track members;
(c) a removable lineal sheet retention cap configured to be engaged, at least in part, by the lineal track member, via male-female type engagement, along at least a portion of:
(i) the first side track; or
(ii) the second side track, and
(c) a first removable lineal trim piece being attachable to the lineal track member, via male-female type engagement, for covering:
(i) the main track and the auxiliary track;
(ii) the first side track; or
(iii) the second side track,
wherein the first removable lineal trim piece comprises two legs for attaching to the lineal track member.

15. The configurable multi-track sheet system of claim 14:
further comprising a second removable lineal trim piece, and
wherein the removable lineal sheet retention cap is configured to be engaged by the first side track;
wherein the first removable lineal trim piece is for covering the main track and the auxiliary track, and
wherein the second removable lineal trim piece is for covering the second side track.

16. The configurable multi-track sheet system of claim 14:
further comprise a second removable lineal trim piece, and
wherein the removable lineal sheet retention cap is configured to be engaged by the first side track;
wherein the first removable lineal trim piece is for covering the second side track; and
wherein the second removable lineal trim piece is for covering the main track and the auxiliary track.

17. The configurable multi-track sheet system of claim 14:
further comprising a second removable lineal trim piece, and
wherein the second removable lineal trim piece is configured to be engaged by the second side track;
wherein the first removable lineal trim piece is for covering the main track and the auxiliary track; and
wherein the second removable lineal trim piece for covering the first side track.

18. The configurable multi-track sheet system of claim 14:
further comprising a second removable lineal trim piece, and
wherein the second removable lineal trim piece is configured to be engaged by the second side track;
wherein the first removable lineal trim piece is for covering the first side track; and
wherein the second removable lineal trim piece is for covering the main track and the auxiliary track.

19. A method of using a configurable multi-track sheet system, the method comprising:
(a) providing a lineal track member having a length and a depth, the lineal track member defining a main track and an auxiliary track each running parallel to the length and perpendicular to the depth, and defining a first side track opposite a second side track each running parallel to the length and perpendicular to the depth;
(b) providing a removable lineal sheet retention member configured to be engaged, at least in part, by the lineal track member, via male-female type engagement, along at least a portion of:
(i) the main track;
(ii) the auxiliary track;
(iii) the first side track; or
(iv) the second side track, and
(c) providing a first removable lineal cap member being attachable to the lineal track member, via male-female type engagement, for covering:
(i) the main track and the auxiliary track;
(ii) the first side track; or
(iii) the second side track.

20. The method of claim 19, further comprising installing the lineal track member onto a substrate via a corner member of the configurable multi-track sheet system that is anchored onto the substrate, or via one or more fasteners extending through the lineal track member and into the substrate, or via a combination of both.
